(19) United States
(12) Patent Application Publication
(10) Pub. No.: US 2006/0212597 A1
(43) Pub. Date: Sep. 21, 2006

(54) Multi-stage load distributing apparatus and method, and program

(75) Inventor: Yuusuke Shimada, Kawasaki (JP)

Correspondence Address: Patrick G. Burns, esq.;GREER, BURNS & CRAIN, LTD., Suite 2500, 300 South Wacker Dr., Chicago, IL, 60606, US

(73) Assignee: FUJITSU LIMITED

(21) Appl. No.: 11/134,823

(22) Filed: May 20, 2005

(30) Foreign Application Priority Data
Feb. 18, 2005 (JP) 2005-041687

(51) Int. Cl. G06F 15/173

(52) U.S. Cl. 709/238

(57) ABSTRACT

A multi-stage load distributing apparatus is constituted of a preceding stage load distributing apparatus connected to a network, a plurality of latter stage load distributing apparatuses connected to the preceding load distributing apparatus, and one or plural servers connected to each latter stage load distributing apparatus, where, after a request from a client is distributed from the preceding stage load distributing apparatus to either of the latter stage load distributing apparatuses, the request is distributed to either of the servers. The latter stage load distributing apparatus is provided with a load status transmitting unit that transmits a status of the server connected itself to the preceding stage load distributing apparatus, and the preceding stage load distributing apparatus is provided with a dynamic distribution control unit that determines a status of the server based upon transmission information from the load status transmitting unit of the latter stage load distributing apparatus to perform allocation control on a request from the client.

This application is a priority based on prior application No. JP 2005-41687, filed Feb. 18, 2005, in Japan.

### BACKGROUND OF THE INVENTION

1. Field of the Invention

The present invention relates to a multi-stage load distributing apparatus, method and program that uses a plurality of load distributing apparatuses arranged in a multi-stage of a preceding stage and a latter stage to cause servers to perform distribution processing of a processing request from a client, and in particular to a multi-stage load distributing apparatus, method and program that dynamically performs load distribution of a multi-stage according to working status of serves.

2. Description of the Related Arts

Conventionally, as a load distribution (load balance) of servers in a server client system utilizing Internet, for example, there is one shown in FIG. 1. In the server load distribution shown in FIG. 1, it is a common practice that a load distributing apparatus 104 is disposed just before a server group provided with servers 110-1 to 110-6 to clients 100-1 and 100-2 connected via Internet 102, and load to servers is distributed by controlling distribution destination to HTTP requests from the client servers 100-1 and 100-2, for example, by round robin. In recent years, however, the load distributing apparatus has not only a simple load distributing function but also various functions such as an SSL (Secure Sockets Layer) accelerator, NAT (Network address Translation) and fire wall. As a result, when server load distribution is performed while using these functions, load on the load distributing apparatus itself increases, so that such a problem occurs that the load distributing apparatus itself constitutes a communication bottleneck. As a solution to the problem, as shown in FIG. 2, there is a method where load distributing apparatuses are disposed in a multi-stage manner to distribute load. In FIG. 2, in the load distribution apparatuses, a preceding stage load distributing apparatus 105 disposed on a side of a network and latter stage load distributing apparatuses 106-1, 106-2, and SSL accelerators 112-1 112-2 disposed on the side of servers 110-1 to 110-6 are disposed in a multi-stage manner, the latter stage load distributing apparatuses 106-1, 106-2 are respectively connected with two of servers 110-1 to 110-4 and the SSL accelerators 112-1, 112-2 are respectively connected with servers 110-5, 110-6. In such a load distribution of a multi-stage constitution, the preceding stage load distributing apparatus 105 performs only distribution of communications from clients 100-1, 100-2 to the latter stage load distributing apparatuses 106-1, 106-2, and the SSL accelerator apparatuses 112-1, 112-2, for example, by round robin, and the latter stage load distributing apparatuses 106-1, 106-2, and the SSL accelerator apparatuses 112-1, 112-2 perform load distribution to the serves 110-1 to 110-4 or accelerator processing to the servers 110-5, 110-6. By function-sharing load distribution in the preceding stage and the latter stage in this manner, the load distributing apparatus itself can be prevented from constituting a communication bottleneck.

[Patent Literature 1] JP-A-2003-122731

In such a conventional multi-stage load distributing method, however, there is such a problem that the preceding load distributing apparatus performs load distribution of client request regardless of failure statuses or load statuses of the servers 110-1 to 110-6 to which the latter stage load distributing apparatus 106-1, 106-2 or the SSL accelerator apparatus 112-1, 112-2 performs distribution. Regarding this problem, since the preceding load distributing apparatus 105 performs management assuming that the latter stage load distributing apparatuses 106-1, 106-2 and the SLL accelerator apparatuses 112-1, 112-2 are distribution destination servers, even if the servers 110-1 to 110-6 positioned at end break down or become high loaded status, the preceding stage load distributing apparatus 105 load-distributes client request to the latter stage load distributing apparatuses 106-1, 106-2 and the SSL accelerator apparatus 112-1, 112-2 in the same manner as an ordinary time, as long as the downstream apparatuses of the latter stage load distributing apparatuses 106-1, 106-2 and the SLL accelerator apparatuses 112-1, 112-2 themselves do not break down or become high loaded status. As a result, for example, when the server 110-2 breaks down, load on the other server 110-1 of the latter stage load distributing apparatus 106-1 to which the server 110-2 broken down belongs becomes high, which means concentration of load to one server, as viewed wholly. When the server 110-5 connected to the SSL accelerator apparatus 112-1 breaks down, if client request is distributed to the SSL accelerator apparatus 112-1, any response can not be obtained due to the server 110-5, so that such a problem occurs that communication becomes impossible, as viewed from the clients 100-1, 100-2. According to the present invention, there are provide a multi-stage load distributing apparatus and method that acquires such a status as load on a server or failure of the server at a preceding stage load distributing apparatus to dynamically determine load distribution to latter stage load control apparatuses to reflect the determination.

### SUMMARY OF THE INVENTION

The present invention is directed to a multi-stage load distributing apparatus constituted of a preceding stage load distributing apparatus connected to a network, a plurality of latter stage load distributing apparatuses connected to the preceding stage load distributing apparatus, and one or plural servers connected to each of the latter stage load distributing apparatuses, where, after request from a client 11 is distributed from the preceding stage load distributing apparatus to either of the latter stage load distributing apparatuses, the request is distributed to either of the servers.

As such a multi-stage load distributing apparatus, in the present invention, a load status transmitting unit that transmits a status of the server connected to the latter stage load distributing apparatus itself is provided in the preceding stage load distributing apparatus, and a dynamic distribution control unit that determines a status of the server based upon transmission information from the load status transmitting unit of the latter stage load distributing apparatus to perform allocation control on a request from a client.

Here, as a transmitting method of load status according to the present invention, there are of an information notifying type, of an information requesting type, and of a composite type obtained by the both.

In the information notifying type, the load status transmitting unit of the latter stage load distributing apparatus embeds transmission information indicating a status of a server connected to the latter stage load distributing apparatus itself in a client response packet from the server to notify the same to the preceding stage load distributing apparatus and the dynamic distribution control unit of the preceding stage load distributing apparatus extracts the transmission information from the client response packet to perform allocation control.

Specifically, the load status transmitting unit of the latter stage load distributing apparatus embeds a server IP address in the header of the client response packet from the server connected to the latter stage load distributing apparatus itself to perform notification, and the dynamic distribution control unit of the preceding load distributing apparatus extracts the server IP address from the header of the client response packet and recognizes the number of servers to each latter stage load distributing apparatus working normally to perform allocation control.

In the case of the information requesting type, the load status transmitting unit of the latter stage load distributing apparatus generates a response of information indicating a status of the server connected to the latter stage load distributing apparatus itself to a request from the preceding stage load distributing apparatus, and the dynamic distribution control unit of the preceding load distributing apparatus requests information indicating a status of the server to the latter stage load distributing apparatus and recognizes the status of the server from response information from the latter stage load distributing apparatus to perform allocation control.

In the case of the composite type, the load status transmitting unit of the latter stage load distributing apparatus embeds a server IP address in the header of the client response packet from the server connected to the latter stage load distributing apparatus to perform notification in a set status of a first mode, while generating a response of information indicating a status of the server connected to the latter stage load distributing apparatus itself to a request from the preceding stage load distributing apparatus in a set status of a second mode, and the dynamic distribution control unit of the preceding load distributing apparatus extracts transmission information from the client response packet to perform allocation control in the set status of the first mode, while requests information indicating a status of the server to the latter stage load distributing apparatus and recognizes the status of the server from response information from the latter stage load distributing apparatus to perform allocation control.

In the composite type, when the preceding stage load distributing apparatus does not receive a client response packet from the latter stage load distributing apparatus at a calculation timing for load distribution ratio in the set mode of the first mode, it performs switching to the set status of the second mode.

When the preceding load distributing apparatus determines that a request frequency from the client is low in the set status of the first mode, it performs switching to the set status of the second mode.

Further, in the set status of the first mode, the load status transmitting unit of the latter stage load distributing apparatus embeds a server IP address in the header of the client response packet from the server connected to the latter stage load distributing apparatus to perform notification, and the dynamic distribution control unit of the preceding load distributing apparatus extracts the server IP address from the header of the client response packet and recognizes the number of servers to each latter stage load distributing apparatus working normally to perform allocation control.

The present invention provides a multi-stage load distributing method. The present invention is a multi-stage load distributing apparatus that is constituted of a preceding stage load distributing apparatus connected to a network, a plurality of latter stage load distributing apparatuses connected to the preceding stage load distributing apparatus, and one or plural servers connected to each latter stage load distributing apparatus, where, after a request from a client is distributed from the preceding stage load distributing apparatus to either of the latter stage load distributing apparatuses, the request is distributed to either of the servers, comprising:

a load status transmitting step of transmitting a status of the server connected to the latter stage load distributing apparatus to the preceding stage load distributing apparatus; and

a dynamic distribution control step of determines a status of the server based upon transmission information obtained by the load status transmitting step to perform allocation control of the request from the client.

The present invention provides a program that is executed at a preceding stage load distributing apparatus constituting a multi-stage load distributing apparatus of an information notifying type.

In a multi-stage load distributing apparatus that is constituted of a preceding stage load distributing apparatus connected to a network, a plurality of latter stage load distributing apparatuses connected to the preceding stage load distributing apparatus, and one or plural servers connected to each latter stage load distributing apparatus, this program causes a computer of the preceding stage load distributing apparatus to execute:

a load status recognizing step of extracting a server IP address embedded in a header of a client response packet received from the latter stage load distributing apparatus to recognize the number of working servers for each the latter stage load distributing apparatus; and

a distributing step of distributing control of client request packet based on the number of the working servers.

The present invention provides a program that is executed in the preceding stage load distributing apparatus constituting a multi-stage load distributing apparatus of an information notifying type. In a multi-stage load distributing apparatus that is constituted of a preceding stage load distributing apparatus connected to a network, a plurality of latter stage load distributing apparatuses connected to the preceding stage load distributing apparatus, and one or plural servers connected to each latter stage load distributing apparatus, this program causes a computer of the latter stage load distributing apparatus to execute:

a step of embedding a server IP address in a header of a client response packet received from a server to transmit the same to the preceding stage load distributing apparatus.

The present invention provides a program that is executed in the preceding stage load distributing apparatus constituting a multi-stage load distributing apparatus of an information requesting type. In a multi-stage load distributing apparatus that is constituted of a preceding stage load distributing apparatus connected to a network, a plurality of latter stage load distributing apparatuses connected to the preceding stage load distributing apparatus, and one or plural servers connected to each latter stage load distributing apparatus, this program causes a computer of the preceding stage load distributing apparatus to execute:

a requesting step of requesting information indicating a status of the server to the latter stage load distributing apparatus;

a load status recognizing step of recognizing the number of working servers from response information for each latter stage load distributing apparatus; and

a distributing step of performing distribution control based on the number of working servers.

The present invention provides a program that is executed in the preceding stage load distributing apparatus constituting a multi-stage load distributing apparatus of an information requesting type. In a multi-stage load distributing apparatus that is constituted of a preceding stage load distributing apparatus connected to a network, a plurality of latter stage load distributing apparatuses connected to the preceding stage load distributing apparatus, and one or plural servers connected to each latter stage load distributing apparatus, this program causes a computer of the latter stage load distributing apparatus to execute:

a response step of generating a response of information indicating a status of the server connected to the latter stage load distributing apparatus itself to information request from the preceding stage load distributing apparatus.

Incidentally, details of the multi-stage load distributing method of the present invention are basically the same as the multi-stage load distributing apparatus of the present invention. According to the present invention, since the preceding stage load distributing apparatus always acquires server information from the latter stage load distributing apparatus to recognize such a status as high load of a server or failure thereof and always calculates a distribution ratio to the severs functioning normally to distribute a request from a client to the latter stage loading distributing apparatuses, such an event is securely prevented from occurring that load is concentrated on a specific server or communication is made impossible by distributing a request from a client to a server broken down, and statuses of servers positioned on an end side can be recognized substantially in real time, so that load distribution optimized to be suitable for server status can be dynamically conducted. In case of a standard protocol such as HTTP, the preceding stage load distributing apparatus extracts an server IP address embedded in a header of a client response packet from a server from the latter stage load distributing apparatus, so that sever information can be acquired simply and securely. When server information can not be embedded in a client response packet due to encryption of SSL or the like, notification is obtained by requiring server information from the preceding stage load distributing apparatus to the latter stage load distributing apparatus, so that sever information can be acquired simply and securely. Further, the first mode is set in an ordinary status, and the preceding stage load distributing apparatus extracts a sever IP address embedded in a header of a client response packet from a server from the latter stage load distributing apparatus. However, when the client response packet can not be received at a calculating time for a distribution ratio due to a temporary slow-down of the latter stage load distributing apparatus or the server or when a request frequency from a client is low, the second mode is set and notification is obtained by requiring server information from the preceding stage load distributing apparatus to the latter stage load distributing apparatus, so that sever information can be securely acquired and an optimal load distribution corresponding to server status at that time can be dynamically realized. The above and other objects, features, and advantages of the present invention will become more apparent from the following detailed description with reference to the drawings.

### BRIEF DESCRIPTION OF THE DRAWINGS

FIG. 1 is an explanatory diagram of a conventional load distributing apparatus;

FIG. 2 is an explanatory diagram of a conventional multi-stage load distributing apparatus;

FIG. 3 is a block diagram of a multi-stage load distributing apparatus according to the present invention, taking a system configuration of an information notifying type;

FIGS. 4A and 4B are block diagrams of a functional configuration of a preceding stage load distributing apparatus and a latter stag load distributing apparatus in FIG. 3;

FIGS. 5A and 5B are explanatory diagrams of the multi-stage load distributing apparatus in FIGS. 4A and 4B;

FIGS. 6A and 6B are explanatory diagrams of an HTTP response packet in FIGS. 5A and 5B;

FIGS. 7A and 7B are explanatory diagrams of a server list provided in the preceding stage load distributing apparatus in FIGS. 4A and 4B;

FIG. 8 is a time chart of a processing in a client, a preceding stage load distributing apparatus, a latter stage load distributing apparatus, and a server in the embodiment of the information notifying type in FIGS. 4A and 4B;

FIG. 9 is a flowchart of the preceding stage load distributing processing in FIGS. 4A and 4B;

FIG. 10 is a flowchart of the latter stage load distributing processing in FIGS. 4A and 4B;

FIG. 11 is a block diagram of the multi-stage load distributing apparatus of the present invention, taking a configuration of an information requesting type;

FIGS. 12A and 12B are block diagrams of a functional configuration of a preceding stage load distributing apparatus and a latter stag load distributing apparatus in FIG. 11;

FIG. 13 is an explanatory diagram of a server list provided in the preceding stage load distributing apparatus in FIGS. 12A and 12B;

FIGS. 14 and 14B are time charts of a processing in a client, a preceding stage load distributing apparatus, a latter stage load distributing apparatus, and a server in the embodiment of the information notifying type in FIG. 11;

FIGS. 15A and 15B are flowcharts of a preceding stage load distributing processing in FIGS. 12A and 12B;

FIG. 16 is a flowchart of a latter stage load distributing processing in FIGS. 12A and 12B;

FIGS. 17A and 17B are block diagrams of a multi-stage load distributing apparatus of the present invention, taking a configuration of a composite type obtained by an information notifying type and an information requesting type;

FIG. 18 is a flowchart of a preceding stage load distributing processing in FIGS. 17A and 17B;

FIG. 19 is a flowchart of a first mode preceding stage load distributing processing in Step S2 in FIG. 18;

FIGS. 20A and 20B are flowcharts of a second mode preceding stage load distributing processing in Step S7 in FIG. 18;

FIG. 21 is a flowchart of a latter stage load distributing processing in FIGS. 17A and 17B;

FIG. 22 is a flowchart of a first mode latter stage load distributing processing in Step S2 in FIG. 21; and

FIG. 23 is a flowchart of a second mode latter stage load distributing processing in Step S4 in FIG. 21.

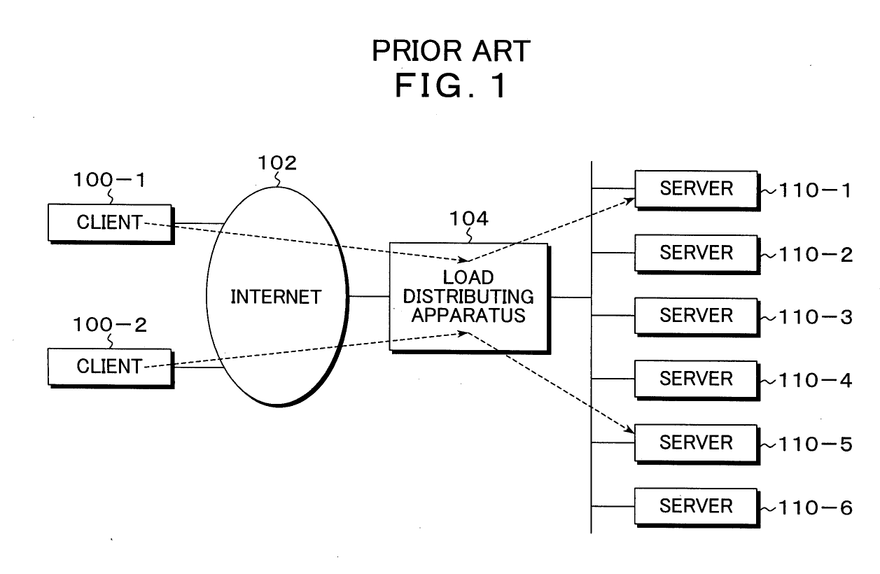

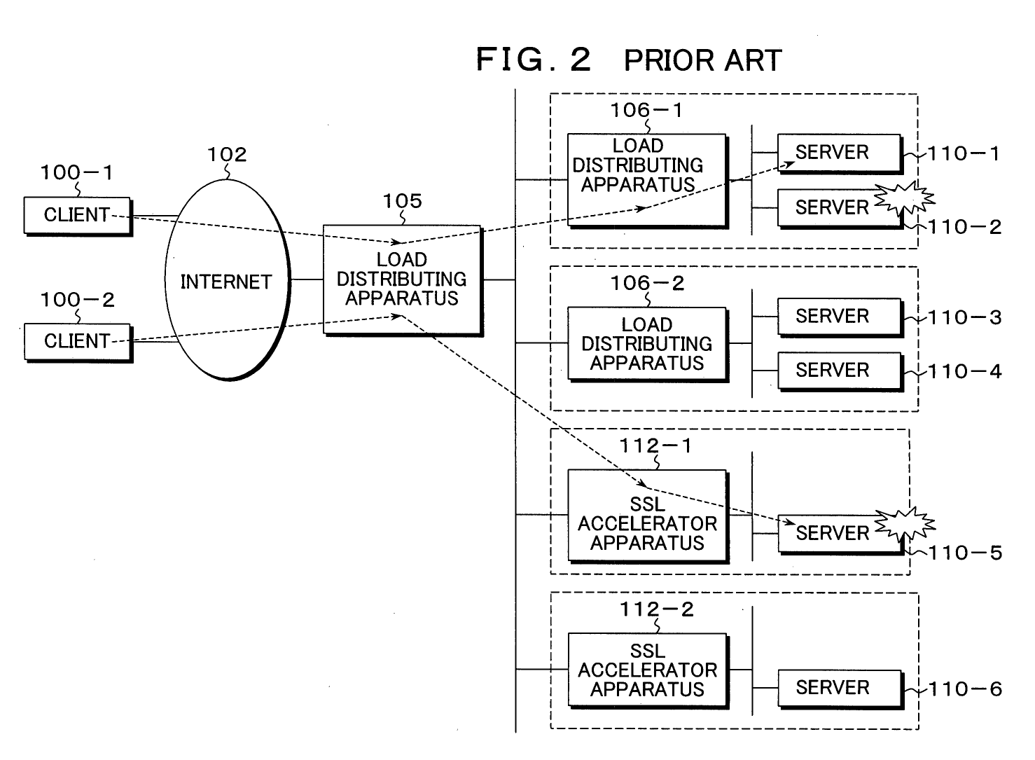

### DETAILED DESCRIPTION OF THE PREFERRED EMBODIMENTS

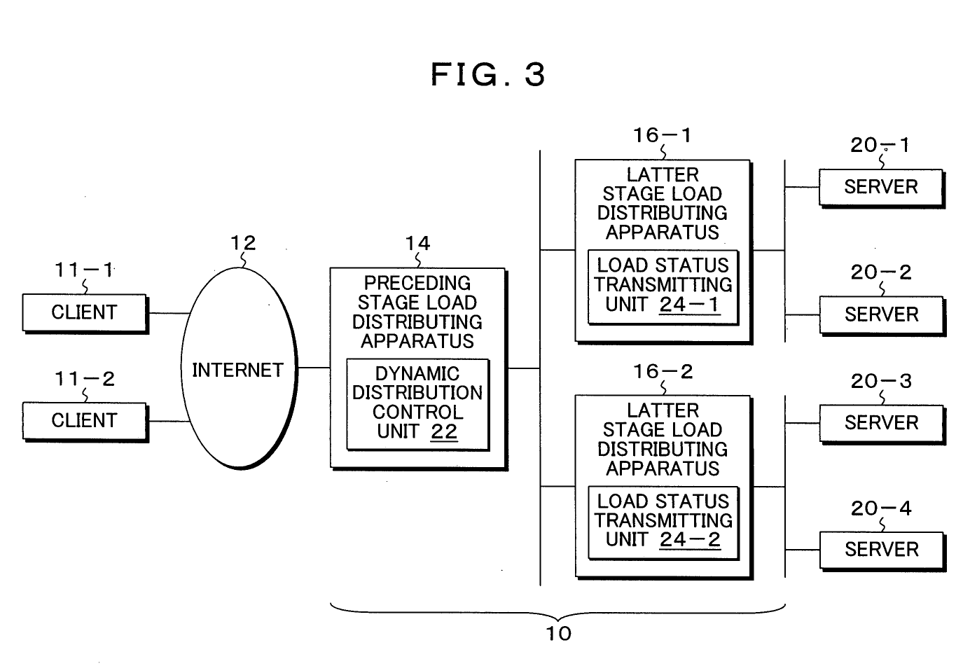

FIG. 3 is a block diagram of a multi-stage load distributing apparatus of the present invention taking a system configuration of an information notifying type. In FIG. 3, a multi-stage load distributing apparatus 10 of the present invention is constituted of a preceding stage load distributing apparatus 14, and a latter stage load distributing apparatuses 16-1, 16-2. The multi-stage load distributing apparatus 10 is connected with clients 11-1, 11-2 via Internet 12, the latter stage load distributing apparatus 16-1 is connected with severs 20-1, 20-2 serving as end servers, and the latter stage load distributing apparatus 16-2 is connected with servers 20-3, 20-4 serving as end servers. In such a multi-stage load distributing apparatus 10 according the present invention, for example, the client 11-1 issues a request to ┌http://www.a.com┘ and, for example, an IP address [10.10.1.100], for example, defining the preceding stage load distributing apparatus 13 as a virtual server is obtained as a destination IP address from name solution of name server, the client 11-1 accesses a virtual server distributed on the preceding stage load distributing apparatus 14 of the multi-stage load distributing apparatus 10 via Internet 12. Specifically, the client 11-1 where an IP address of the client 11-1 is [172.16.10.55] and an IP address of the preceding stage load distributing apparatus is [10.10.1.100] transmits an HTTP request packet to the preceding stage load distributing apparatus 14 via Internet 12 as Source IP address=172.16.10.55 and Destination IP address=10.10.1.100.

Incidentally, a port number is also set to the source IP address, but it is omitted. When the preceding stage load distributing apparatus 14 receives the HTTP request packet from the client 11-1, for example, it selects the latter stage load distributing apparatus 16-1 from two latter stage load distributing apparatuses 16-1, 16-2 according to a distribution ratio calculated according to the processing of the present invention made clear from explanation described later to transfer the HTTP request packet to the latter stage load distributing apparatus 16-1. Specifically, the preceding stage load distributing converts the destination IP address to the IP address “192.168.255.10” of the latter stage load distributing apparatus 16-1 to transmit the packet, while maintaining the source IP address. The latter stag load distributing apparatus 16-1 selects an optimal server, for example, the server 20-1, from current working or active servers 20-1, 20-2 according to a load distributing algorithm to perform processing. Specifically the latter stag load distributing apparatus 16-1 converts the destination IP address to the IP address “192.168.250.10” of the server 20-1 to send the packet, while maintaining the source IP address of the HTTP request packet. The server 20-1 that has received the client request packet prepares an HTTP response packet correspond to request content to send the packet to the latter stage load distributing apparatus 16-1 as Source IP address=192.168.250.10 and Destination IP address=192.168.250.10. The latter stage load distributing apparatus 16-1 converts the destination IP address to “10.10.1.100” to send the HTTP response packet to the preceding stage load distributing apparatus 14. The preceding stage load distributing apparatus 14 converts the destination IP address to “172.16.10.55”, while holding the source IP address as it is, to send the HTTP response packet to Internet 12, and the client 11-1 receives the HTTP response packet to perform web paged display or the like. Incidentally, a load distributing algorithm set in the latter stage load distributing apparatus 16-1 is a load distributing algorithm commonly used. For example, a round robin system where servers are selected in order, a minimum connecting system where a server with the minimum number of connections in processing is selected, a fastest system where a server responds fastest, or the like is used. The multi-stage load distributing apparatus 10 is constituted according to the constitution of the information notifying type such that the preceding stage load distributing apparatus 14 acquires server information indicating statuses of the servers 20-1 to 20-4 serving as end servers connected to the latter stage load distributing apparatuses 16-1, 16-2 and it determines distribution destination to the latter stage load distributing apparatuses 16-1, 16-2 based upon the server information. Therefore, the preceding stage load distributing apparatus 14 is provided with a dynamic distribution control unit 22, and the latter stage load distributing apparatuses 16-1, 16-2 are provided with the load status transmitting units 24-1, 24-2. The load status transmitting units 24-1, 24-2 provided in the latter stage load distributing apparatuses 16-1, 16-2 have functions that transmit statuses of the servers connected to the latter stage load distributing apparatuses 16-1, 16-2 themselves to the preceding stage load distributing apparatus 14. Since the embodiment takes an aspect of the information notifying type, the load status transmitting units 24-1, 24-2 embed transmission information indicating server statuses in client response packets from servers connected to themselves to perform notification.

Specifically, the load status transmitting unit 24-1 embeds, in a header of an HTTP response packet from the server 20-1 or 20-2 connected to the latter stage load distributing apparatus 16-1, an IP address of the server to send the same to the preceding stage load distributing apparatus 14. The dynamic distributing control unit 22 provided in the preceding stage load distributing apparatus 14 determines statuses of the servers 20-1 to 20-4 based upon transmission information from the load status transmitting units 24-1, 24-2 of the latter stage load distributing apparatuses 16-1, 16-2 to control allocation of HTTP request packets from the clients 11-1, 11-2. As a processing in the aspect of the information notifying type of the dynamic distribution control unit 22, the load status transmitting units 24-1, 24-2 of the latter stage load distributing apparatuses 16-1, 16-2 extract server IP addresses embedded in headers of HTTP response packets to prepare a server list, recognize the numbers of serves working normally in the latter stage load distributing apparatuses 16-1, 16-2, calculate a distribution ratio from the numbers of serves working, and determine distribution destination of HTTP request packets according to the calculated distribution ratio.

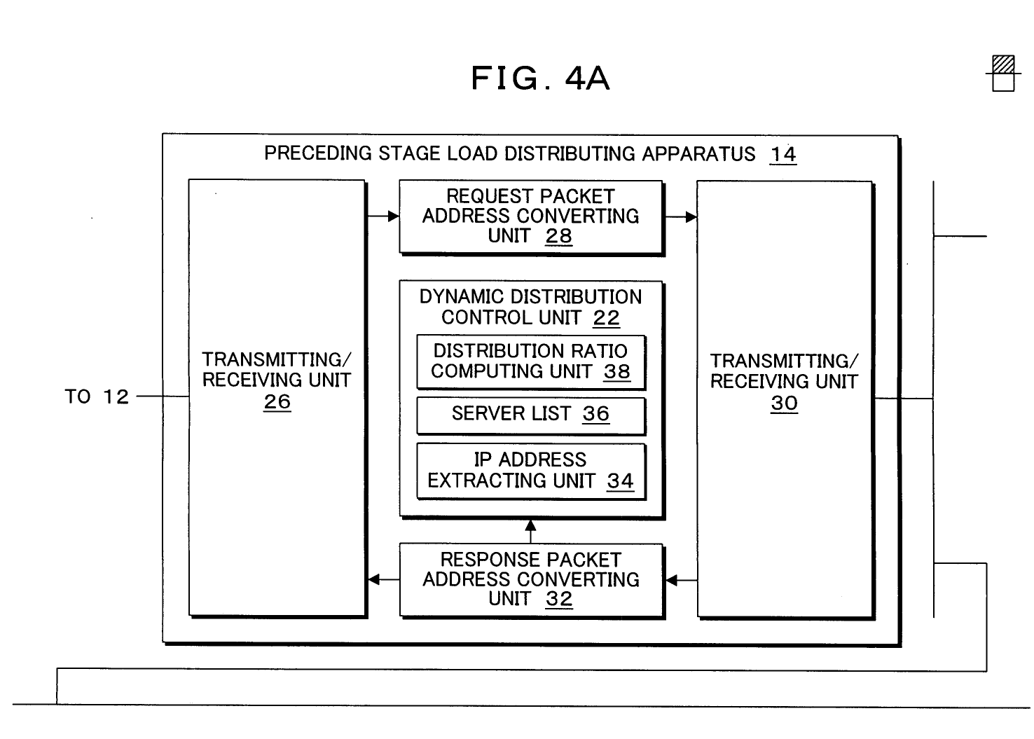

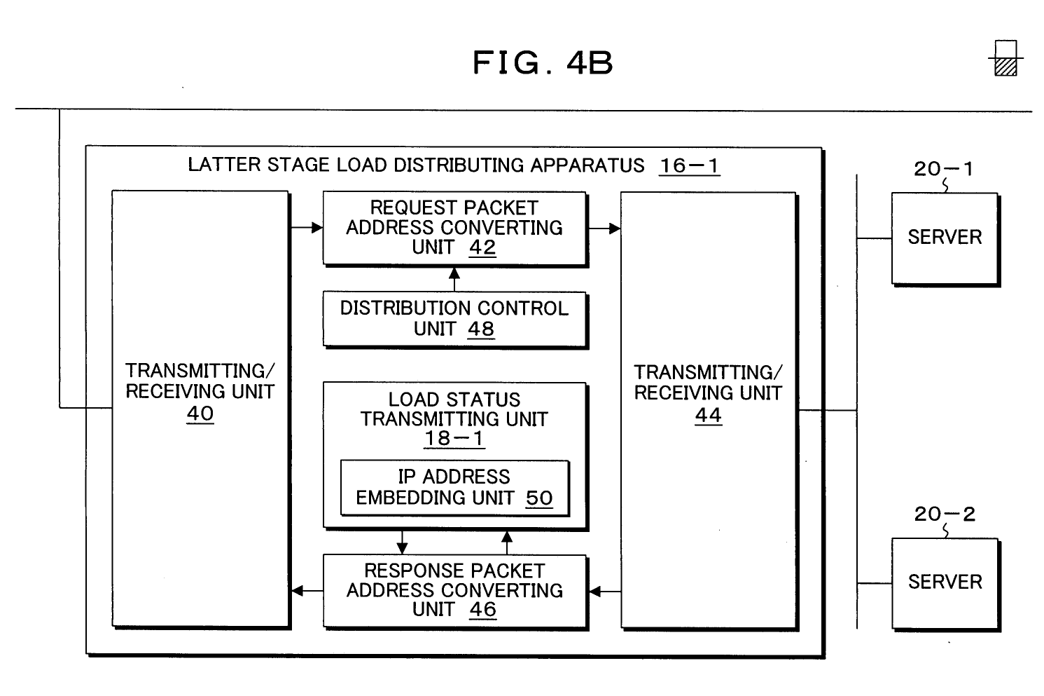

FIGS. 4A and 4B are block diagrams showing function configurations of the preceding stage load distributing apparatus 14 and the latter stage load distributing apparatus 16-1 taken out of FIG. 3. In FIGS. 4A and 4B, the preceding stage load distributing apparatus 14 has a transmitting/receiving unit 26 connected to Internet 12 and a transmitting/receiving unit 30 connected to the latter stage load distributing apparatus 16-1, and it is provided therebetween with a request packet address converting unit 28 and a response packet address converting unit 32. Further, the dynamic distribution control unit 22 is provided, and an IP address extracting unit 34, a server list 36, and a distribution ratio calculating unit 38 are provided in the dynamic distribution control unit 22. The request packet address converting unit 28 converts a destination IP address of an HTTP request packet to an IP address of the latter stage load distributing apparatus 16-1 or 16-2 determined at the dynamic distribution control unit 22 from the preceding stage load distributing apparatus 14. The response packet address converting unit 32 converts a destination address of an HTTP response packet received at the transmitting/receiving unit 30, for example, from the latter stage load distributing apparatus 16-1 to an IP address of a client that is a request source from the IP address of the latter stage load distributing apparatus 16-1. The IP address extracting unit 34 provided in the dynamic distribution control unit 22 extracts an IP address of the server 20-1 or 20-2 embedded in the HTTP response packet from the latter stage load distributing apparatus 16-1 received at the transmitting/receiving unit 30 to register the same in the server list 36. The distribution ratio calculating unit 38 refers to the server list for each constant calculating timing to acquire, for example, the number of working servers for each of the latter stage load distributing apparatuses 16-1, 16-2 from server IP addresses registered in the sever list 36, calculates a distribution ratio to the latter stage load distributing apparatuses 16-1, 16-2 based upon the number of working servers, and performs determination processing of HTTP request packets to the latter stage load distributing apparatuses 16-1, 16-2 according to the calculated distribution ratio until a timing reaches the next distribution ratio calculating timing. The latter stage load distributing apparatus 16-1 is provided with a transmitting/receiving unit 40 connected to the preceding stage load distributing apparatus 14, a transmitting/receiving unit 44 connected to the servers 20-1, 20-2, a request packet address converting unit 42, a response packet address converting unit 46, a distribution control unit 48, and a load status transmitting unit 18-1, and the load status transmitting unit 18-1 is provided with an IP address embedding unit 50. The request packet address converting unit 42 converts a destination IP address of an HTTP request packet from the preceding stage load distributing apparatus 14 received at the transmitting/receiving unit 40 to, for example, an IP address of the server 20-1. The response packet address converting unit 46 converts a destination address of an HTTP response packet from, for example, the server 20-1 to the IP address of the preceding stage load distributing apparatus 14. The distribution control unit 48 allocates the HTTP request packet to the server 20-1 or 20-2 according to an ordinary distribution algorithm such as the round robin system, the minimum connecting system, or the fastest connecting system. When the load status transmitting unit 18-1 receives an HTTP response packet from the server 20-1, 20-3, it embeds the IP address of the sever 20-1 or 20-2 serving as a source IP address into a header of the HTTP response packet to transmit the HTTP response packet to the preceding stage load distributing apparatus 14.

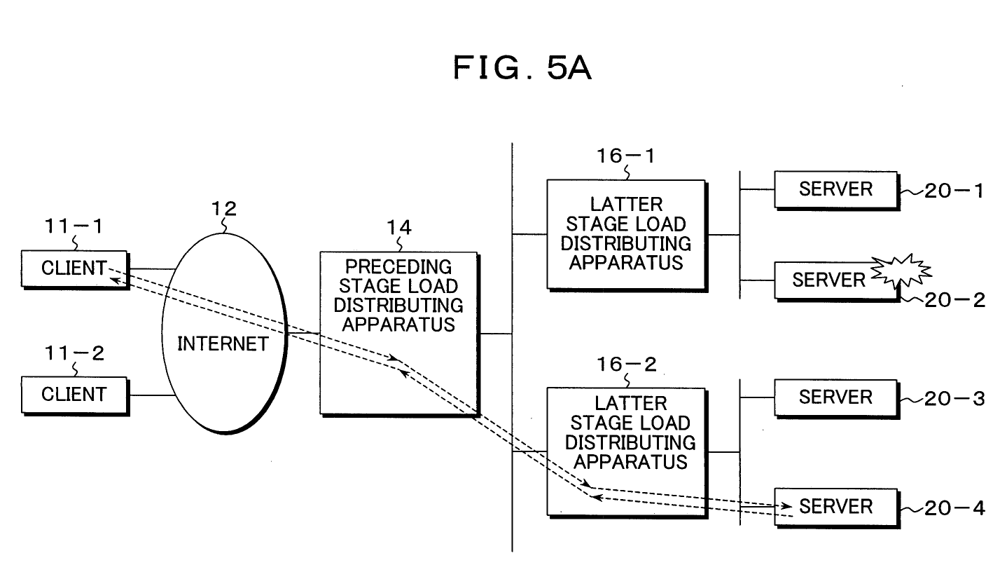

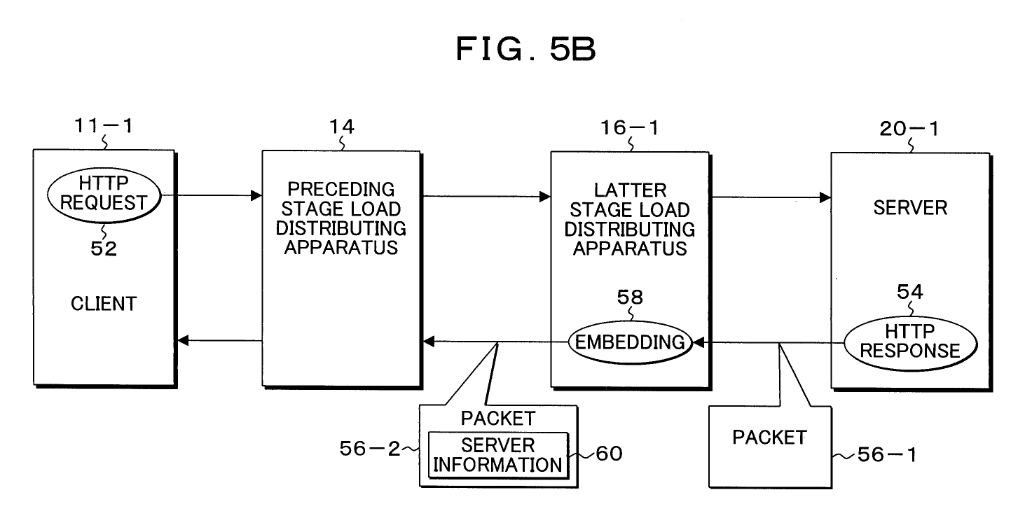

FIGS. 5A and 5B are explanatory diagrams of the multi-stage load distributing apparatus in FIGS. 4A and 4B. FIG. 5A shows a case that HTTP request packets are transmitted from the client 11-1 to the multi-stage load distributing apparatus 10 of the present invention, where the packets are allocated to the latter stage load distributing apparatus 16-2 and to the server 20-3, 20-4 serving as the end server by the preceding stage load distributing apparatus 14. An HTTP response packet from the sever 20-4 is set from the latter stage load distributing apparatus 16-2 and the preceding stage load distributing apparatus 14 to the client 11-1 via Internet 12. FIG. 5B shows processings in respective units in packet transfer in FIG. 5A. The client 11-1 transmits a packet according to HTTP request 52, allocates the packet to the latter stage load distributing apparatus 16-1 according to dynamic load distribution control performed by the preceding stage load distributing apparatus 14, and further transmits the same to the server 20-1. The server 20-1 performs HTTP response 54 to transmit an HTTP response packet 56, and the latter stage load distributing apparatus 16-1 receives the packet 56 to send an HTTP response packet 56-2 perpared by embedding server information 60 of the server 20-1 in the HTTP response packet 56 to send the same to the preceding stage load distributing apparatus 14. The preceding stage load distributing apparatus 14 extracts the server information 60 from the HTTP response packet 56-2 to dynamically perform the HTTP request packet to the latter stage load distributing apparatus 16-1, 16-2 according to calculation of the distribution ratio based upon, for example, the number of working severs.

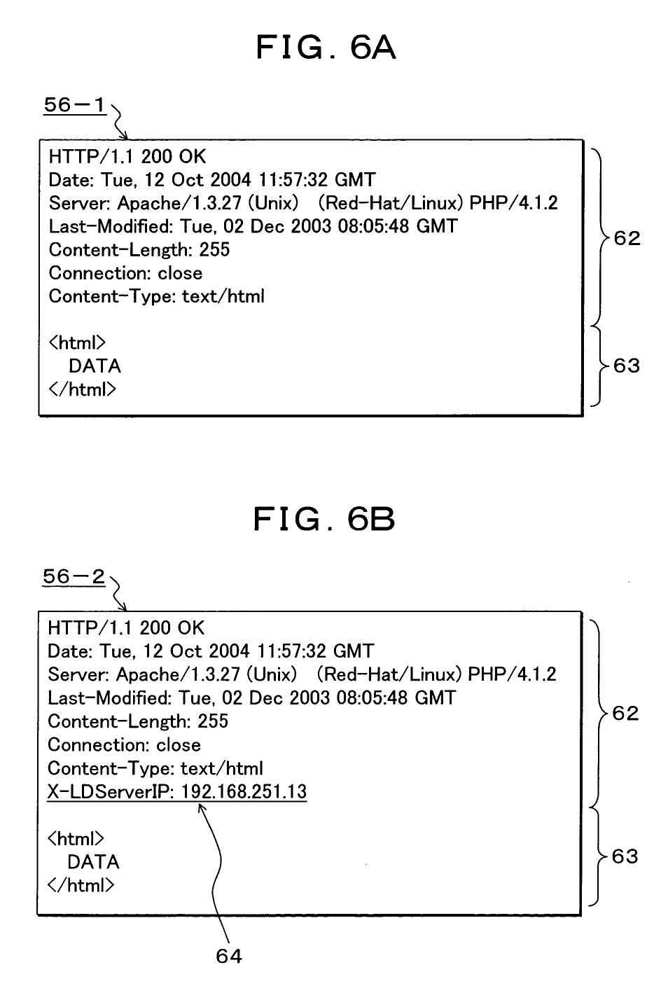

FIGS. 6A and 6B are explanatory diagrams of HTTP response packets in FIG. 5B. FIG. 6A is a diagram showing an original HTTP response packet that the sever 20-1 in FIG. 5B has transmitted, which is constituted of a header 62 and a body 63. FIG. 6B is a diagram showing an HTTP response packet 56-2 where a server IP address 64 has been embedded in a portion of the header 62 as server information of the server 20-1 by the latter stage load distributing apparatus 16-1. The HTTP response packet 56-2 additionally stores “X-LDServerIP: 192.168.251.13” in the header 62 as a server IP address 64, and since there is no change in header information before the server IP address, the header information is not injured functionally at all. When the HTTP response packet 56-2 is received at the preceding stage load distributing apparatus 14, the server IP address 64 is extracted from the header 62 to be registered in the server list 36. It is desirable that, after extraction of the header address 64 is completed, the header address is deleted from the header 62, but even if the header address 64 remains in the server IP header 62, it is ignored in the course of packet processing to the client, so that there is not a problem especially.

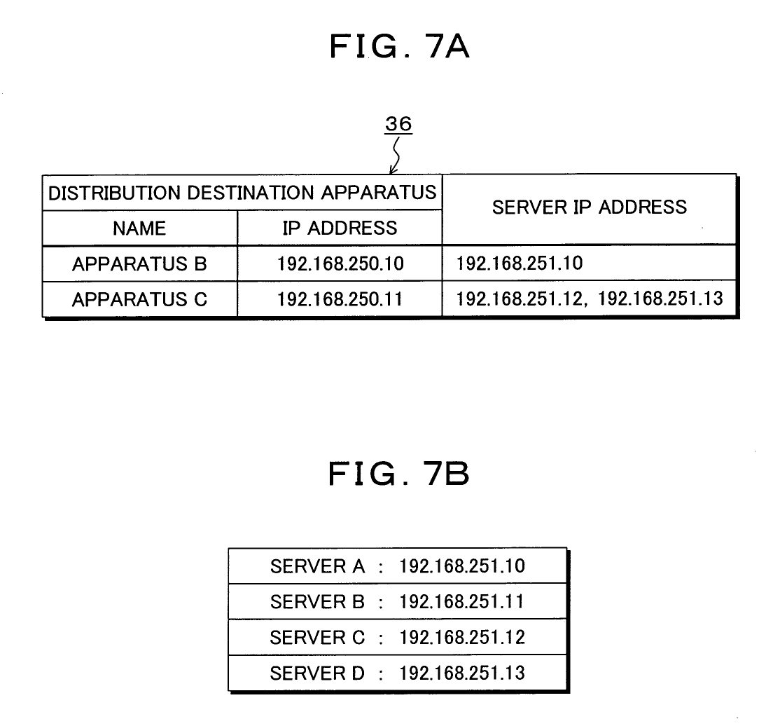

FIGS. 7A and 7B are explanatory diagrams of the server list 36 provided in the preceding stage load distributing apparatus 14 in FIGS. 4A and 4B. FIG. 7A is a diagram of the server list 36, where name IP addresses are provided to distributing apparatuses, and server IP addresses are registered to correspond to the distributing apparatuses. FIG. 7B is a diagram of a list of IP addresses of the servers 20-1 to 20-4 in FIG. 5A. In FIGS. 5A and 5B, since the server 20-2 breaks down, an HTTP response packet from the server 20-2 is not received, so that the IP address of the server 20-1 is registered in the server list 36 corresponding to the latter stage load distributing apparatus 16-1, and the server IP addresses of the servers 20-3, 20-4 are registered corresponding to the latter stage load distributing apparatus 16-2. The distribution ratio calculating unit 38 shown in the preceding stage load distributing apparatus 14 in FIGS. 4A and 4B determines a distribution ratio to the latter stage load distributing apparatuses 16-1, 16-2 from the number of working servers serving as end serves registered in the server list 36 shown in FIG. 7A according to, for example, the following calculation equation.
(Distribution Ratio)=(Safety Margin of distribution destination transmission/reception)+(Number of working servers under distribution destination)×(Weight) (1)

For example, assuming that the weight is set to “5” and “0” is set without considering loads on the latter stage load distributing apparatuses 16-1, 16-2 themselves that are distribution destination apparatuses, the distribution ratio to the latter stage load distributing apparatuses 16-1, 16-2 according to the sever list 36 shown in FIG. 7A is as follows:

Latter stage load distributing apparatus 16-1: 0+1×5=5

Latter stage load distributing apparatus 16-2: 0+2×5=10

Accordingly, allocation is performed to the latte stage load distributing apparatuses 16-1, 16-2 as the ratio of

(Latter stage load distributing apparatus 16-1):

(Latter stage load distributing apparatus 16-2)=1:2

Further, when all the serves 20-1, 20-2, or 20-3, 20-4 under the control of the latter stage load distributing apparatuses 16-1, 16-2 break down, the latter stage load distributing apparatuses 16-1, 16-2 return HTTP response packets indicating all server breakdown. For example, when the preceding stage load distributing apparatus 14 receives the HTTP response packets of the all server breakdown from the latter stage load distributing apparatuses 16-1, 16-2, it suppresses distributing to the latter stage load distributing apparatuses 16-1, 16-2 that are transmission sources. As a method for detecting recovery of the servers 20-1, 202 thereafter, there are two following methods.
(1) An HTTP request packet is periodically transmitted from the preceding stage load distributing apparatus 14 to the latter stage load distributing apparatus 16-1 that has notified the breakdown of all servers and a response packet thereto is monitored.
(2) HTTP request packets from a client are distributed to the latter stage load distributing apparatus 16-1 with the breakdown of all servers for each some times, and a response packet thereto is monitored. In the both methods, when an HTTP response packet embedded with the server information of either end server of the serves all broken down is returned, the preceding stage load distributing apparatus 14 determines end server recovery to restart a dynamic allocating processing.

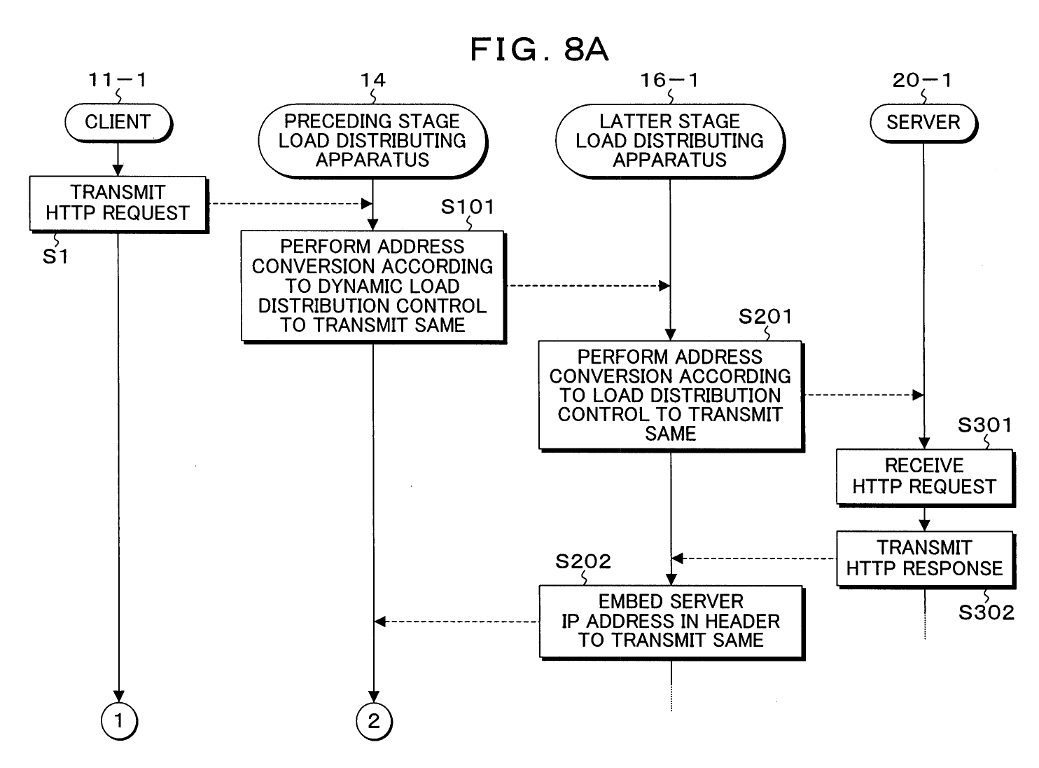

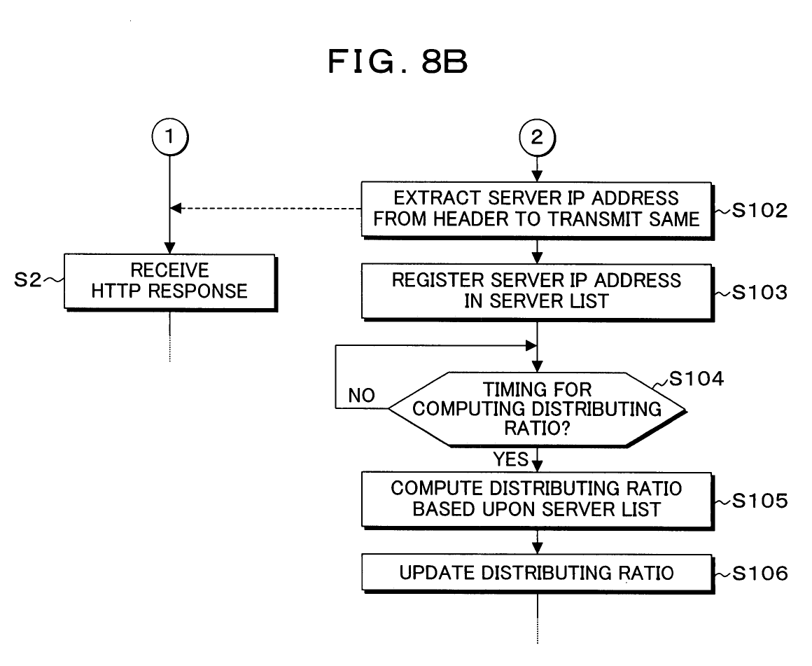

FIG. 8 is a time chart of processings of the preceding stage load distributing apparatus, the latter stage load distributing apparatuses, and the server in the embodiment of the information notifying type shown in FIGS. 4A and 4B. In FIG. 8, when the client 11-1 transmits an HTTP response packet in Step S1, the preceding stage load distributing apparatus 14 receives the packet, determines, for example, the latter stage load distributing apparatus 16-1 as an allocation destination by dynamic load distribution control according to the calculated distribution ratio, and converts a destination address of the HTTP request packet from the preceding stage load distributing apparatus 14 to the latter stage load distributing apparatus 16-1 to transmit the HTTP request packet in Step S101. The latter stage load distributing apparatus 16-1 determines the server 20-1 as an allocation destination according to the load distribution control of, for example, a round robin set in advance and address-converts the destination IP address from the latter stage load distributing apparatus 16-1 to the server 20-1 to transmit the packet. The server 20-1 receives the HTTP request packet to perform a necessary processing from data thereof in Step S302, and transmits an HTTP response packet whose source IP address is set to the server 20-1 and whose destination IP address is set to the latter stage load distributing apparatus 16-1 in Step S302. The latter stage load distributing apparatus embeds a server IP address of the server 20-1 that is a response source in a header of the HTTP response packet and converts the destination address to the preceding stage load distributing apparatus 14 to transmit the HTTP response packet in Step S202. After the preceding stage load distributing apparatus 14 extracts the server IP address from the header of the HTTP response packet to register the same in a server list, it converts the destination address to an IP address of the client 11-1 to send the HTTP response packet in Step S101. Incidentally, at that time, the packet may be transmitted after the server IP address is removed from the header. The client 11-1 receives the HTTP response packet from the preceding stage load distributing apparatus 14 to perform web page display or the like based upon the received data in Step S2. After the preceding stage load distributing apparatus 14 registers the server IP address extracted in the server list in Step S103, it checks whether or not a timing reaches a calculating timing for the distribution ratio in Step S104. When the timing reaches the calculating timing, the preceding stage load distributing apparatus 14 calculates a distribution ratio based upon the server list in Step S105 and updates the distribution ratio in Step S106. Thereby, the distribution ratio corresponding to a working status of the servers during each of cycles of calculating timings for the distribution ratio is calculated and a dynamic distribution control performing allocation of the distribution destinations to the latter stage load distribution apparatus can be performed from the optimal preceding stage distributing apparatus dynamically corresponding to the working status of the servers.

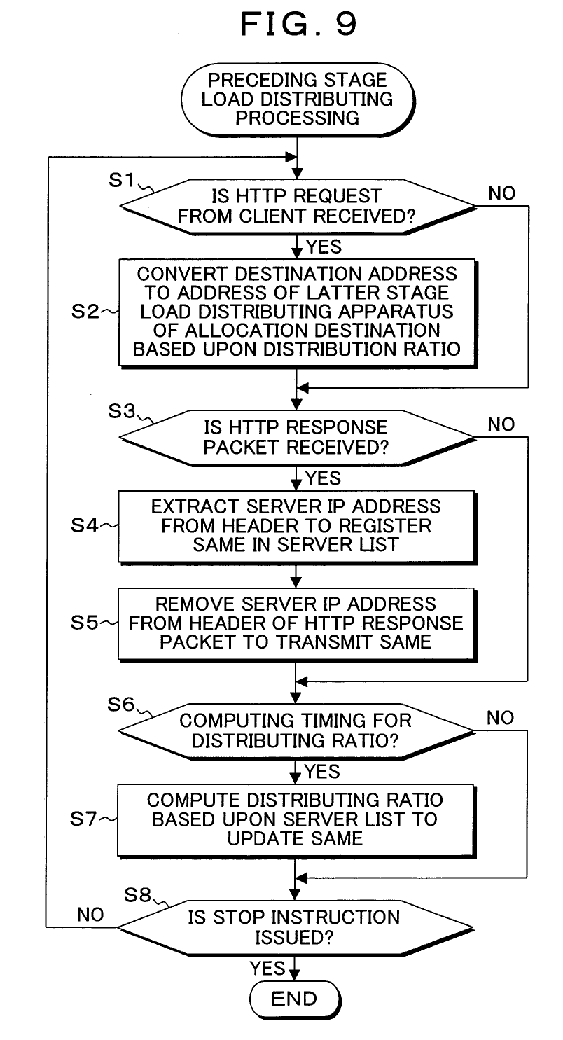

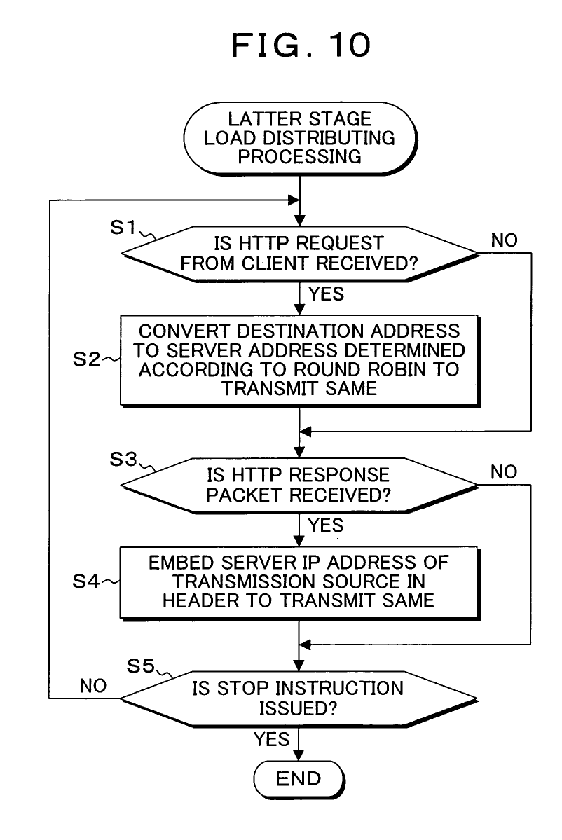

FIG. 9 is a flowchart of a preceding stage load distributing processing in the preceding stage load distributing apparatus 14 in FIGS. 4A and 4B. In FIG. 9, the preceding stage load distributing processing checks presence/absence of reception of an HTTP request packet from the client in Step S1. When a packet reception occurs, the preceding stage load distributing processing proceeds to Step S2, where the destination address is converted to the IP address of the latter stage load distributing apparatus based upon the distribution ratio and the HTTP request packet is transmitted. The preceding stage load distributing processing checks presence/absence of reception of an HTTP response packet in Step S3. Upon reception of a packet, the preceding stage load distributing processing extracts an IP address from a header to be registered in the server list in Step S4, and thereafter it removes a server IP address and transmits the packet in Step S5. The preceding stage load distributing processing checks the calculating timing for the distribution ratio in Step S6, and when a timing reaches the calculating timing, the processing proceeds to Step S7, where the distribution ratio is calculated based upon the server list to be updated. The processing in these Steps S1 to S7 is repeated until a stop instruction is issued in Step S8. FIG. 10 is a flowchart of a latter stage load distributing processing in the latter stage load distributing apparatuses 16-1, 16-2. In FIG. 10, the latter stage load distributing processing checks presence/absence of reception of an HTTP request packet of a client in Step S1. Upon receipt of a packet, the latter stage load distributing processing converts a destination address to a server IP address determined by, for example, a round robin system in Step S2. The latter stage load distributing processing checks presence/absence of reception of an HTTP response packet in Step S3. Upon reception of a packet, the latter stage load distributing processing embeds a server IP address of a transmission source in a header and transmits the packet in Step S4. The processing in these Steps S1 to S4 is repeated until a stop instruction is issued in Step S5.

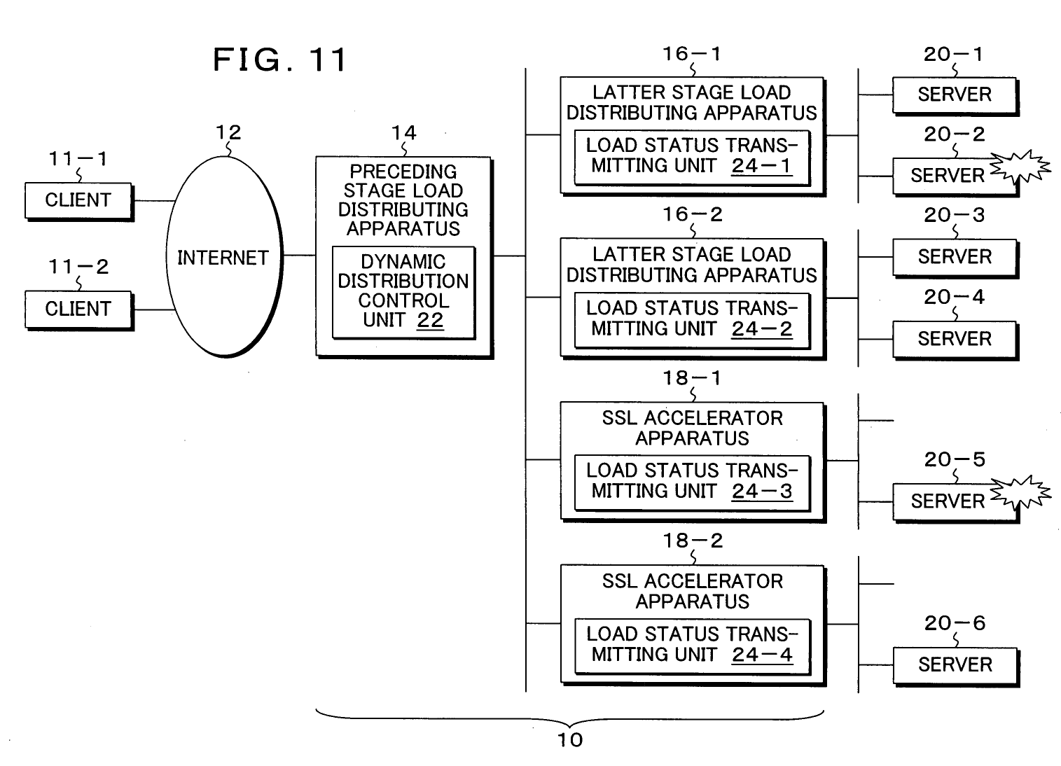

FIG. 11 is a block diagram of the multi-stage load distributing apparatus of the present invention, taking a configuration of the information requesting type. The embodiment shown in FIG. 11 is directed to a case that SSL accelerator apparatuses 18-1, 18-2 are disposed in addition to the latter stage load distributing apparatuses 16-1, 16-2 connected to the preceding stage load distributing apparatus 14 of the multi-stage load distributing apparatus 10. In the case of the SSL accelerator apparatuses 18-1, 18-2, since server information can not be embedded in an HTTP response packet from a server, which is different from the latter stage load distributing apparatuses 16-1, 16-2, a configuration of an information requesting type is taken as a method for acquiring server information in the embodiment. Here, the SSL accelerator apparatuses 18-1, 18-2 perform a protocol that can conduct server authentication, or client authentication and encryption communication. As well known, in a web browser for the clients 10-1, 10-2, HTTP and HTTP using SSL are discriminated from each other based upon difference in URL, namely, “http://” and “https://”. On the other hand, communications of HTTP and HTTP using SSL are discriminated on the side of the server including the multi-stage load distributing apparatus 10 by using port number 40 for the former and using port number 443 for the latter. Even when the SSL accelerator apparatuses 18-1, 18-2 are disposed on the latter stage load distributing apparatuses 16-1, 16-2 as distribution destinations in this manner, a dynamic distribution control unit 22 is provided in the preceding stage load distributing apparatus 14, while load status transmitting apparatuses 24-1 to 24-4 are provided in the latter stage load distributing apparatuses 16-1, 16-2 and the SSL accelerator apparatuses 18-1, 18-2, so that server information can be acquired in the preceding stage load distributing apparatus 14 according to the configuration of the information requesting type between the both.

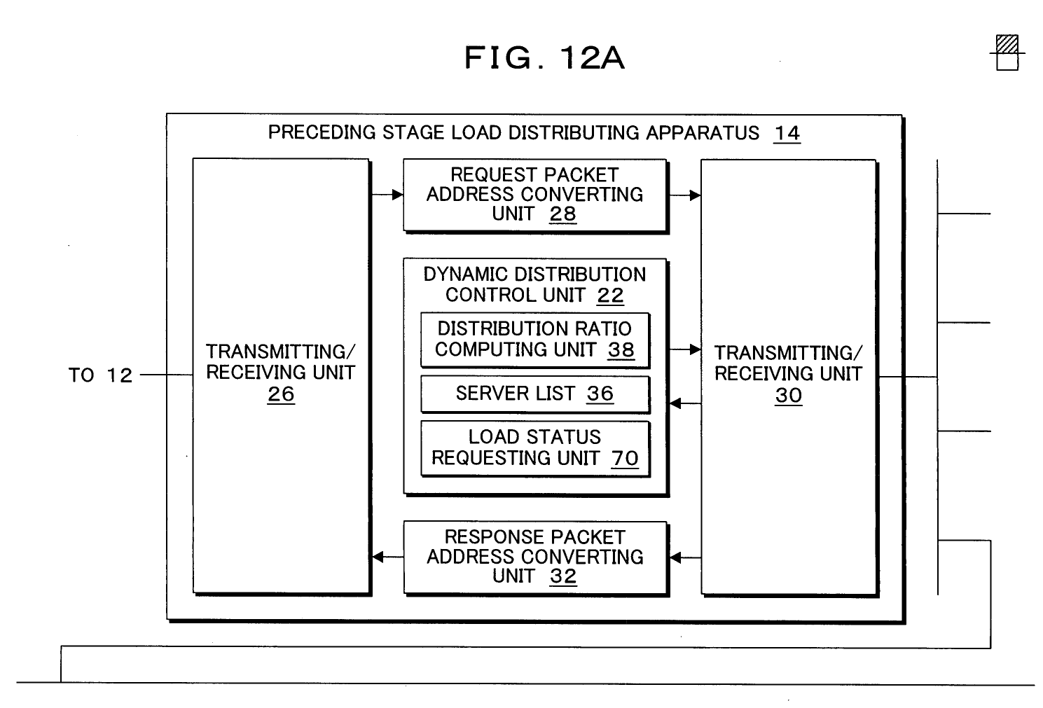

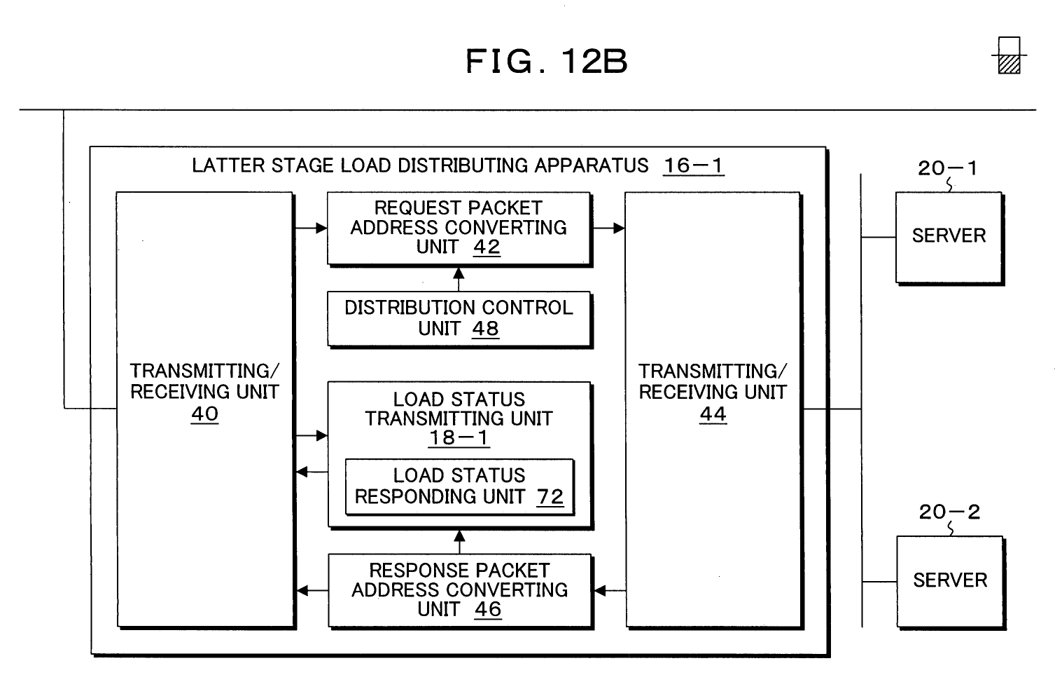

FIGS. 12A and 12B are block diagrams of a functional configuration of the preceding stage load distributing apparatus 14 and the latter stage load distributing apparatus 16-1. The preceding stage load distributing apparatus 14 is provided with transmitting/receiving units 26, 30, a request packet address converting unit 28, and a response packet address converting unit 32, which is the same as the case of the information notifying type shown in FIGS. 4A and 4B. On the other hand, a load status requesting unit 70 is provided in the dynamic distribution control unit 22 as a configuration inherent to the information requesting type. The load status requesting unit 70 requests server information to the latter stage load distributing apparatuses 16-1, 16-2 and the SSL accelerator apparatuses 18-1, 18-2 at a constant time interval. A protocol for server information request conducted by the load status requesting unit 70 can be realized as a proper application program using any program used in TCP-IP protocol. The load status requesting unit 70 acquires, for example, the number of working servers based upon server information acquired by performing server status request at fixed time intervals to register the same in the server list 36. The distribution ratio calculating unit 38 calculates a distribution ratio to the latter stage load distributing apparatuses 16-1, 16-2, and the SSL accelerator apparatuses 18-1, 18-2 based upon the number of working servers in the server list 36 for each calculating timing to dynamically determine allocation destinations of HTTP request packets from a client. The latter stage load distributing apparatus 16-1 is provided with transmitting/receiving units 40, 44, a request packet address converting unit 42, a response packet address converting unit 46, and a distribution control unit 48, which is the same as the case of the information notifying type shown in FIGS. 4A and 4B. Further, a load status responding unit 72 inherent to the information requesting type is provided in the load status transmitting unit 18-1. When the load status responding unit 72 receives a request for server information from the load status requesting unit 70 provided in the preceding load distributing apparatus 14, it transmits information about working servers connected to the transmitting/receiving unit 44 at that time, for example, working server information to the preceding load distributing apparatus 14 as response.

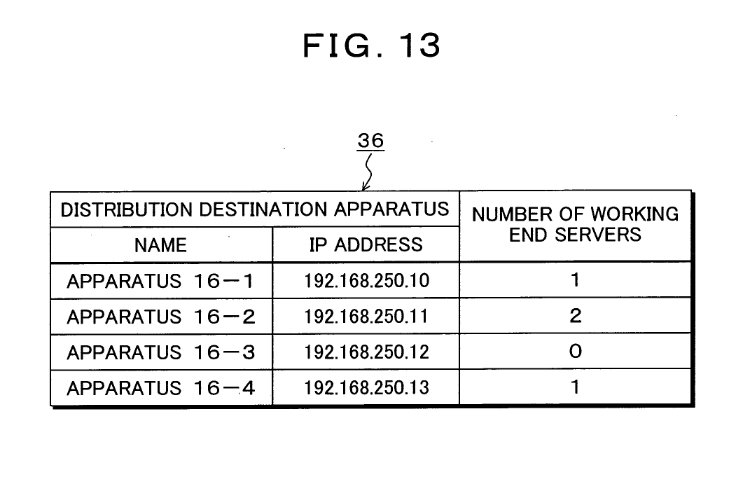

FIG. 13 is an explanatory diagram of the server list 36 provided in the preceding load distributing apparatus 14 shown in FIGS. 12A and 12B. In FIG. 11, assuming that two servers of the server 20-2 and server 20-5 are now stopping due to breakdown, the latter status load distributing apparatuses 16-1, 16-2, and the SSL accelerator apparatuses 18-1, 18-2 notify the number of working servers connected to themselves in response to a request for server information from the load status requesting unit 70 of the preceding stage load distributing apparatus 14 and receive the notification to register the same in the server list 36. FIG. 13 is an explanatory diagram of a server list 36 obtained at that time, where the latter status load distributing apparatuses 16-1, 16-2, and the SSL accelerator apparatuses 18-1, 18-2 are registered as names of distribution destination apparatuses together with respective IP addresses and the number of working end server acquired according to the processing of the information requesting type corresponding thereto is registered. The distribution ratio calculating unit 38 shown in FIGS. 12A and 12B calculates a distribution ratio to the latter stage load distributing apparatuses based upon the number of working end servers in the server list 36 shown in FIG. 13 according to the above-mentioned (1) equation like the case of the information notifying type. The distribution ratio to the latter load distributing apparatuses according to the server list 36 shown in FIG. 13 is as follows:

Latter stage load distributing apparatus 16-1: 0+1×5=5

Latter stage load distributing apparatus 16-2: 0+2×5=10

SSL accelerator apparatus: 18-1: 0+0×5=0 (=outside allocation subject)

SSL accelerator apparatus: 18-2: 0+1×5=5

Accordingly, in this case, allocation is performed with a ratio of

(apparatus 16-1):(apparatus 16-2):(apparatus 18-1):(apparatus 18-2)=1:2:0:1.

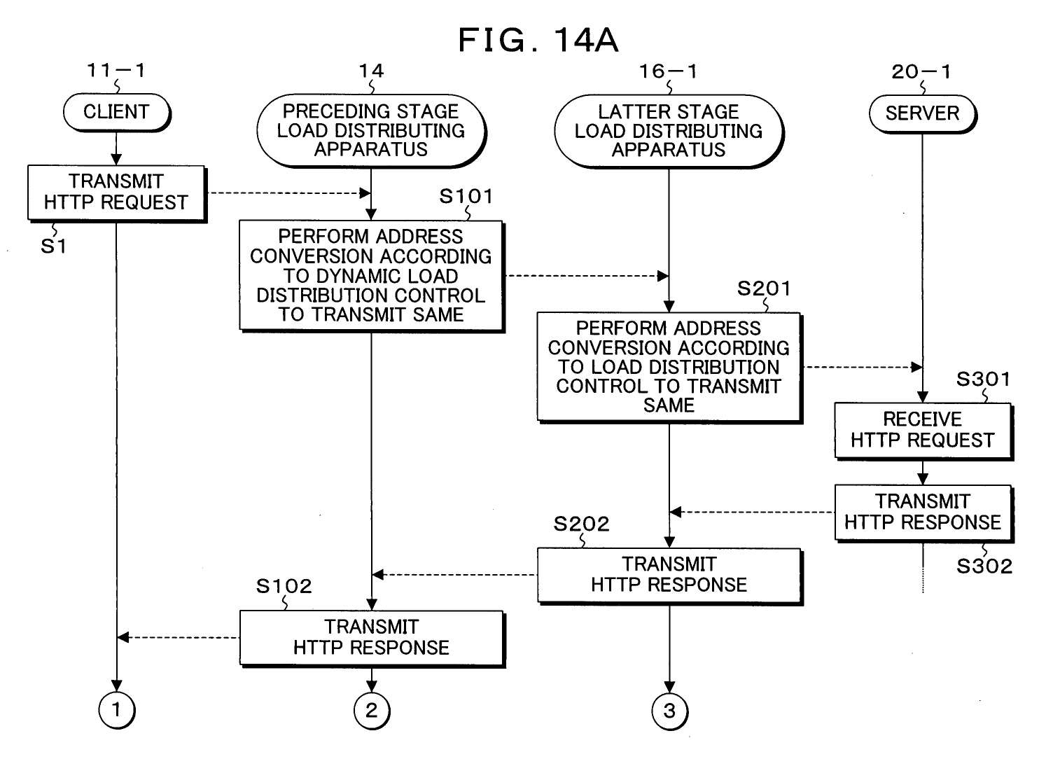

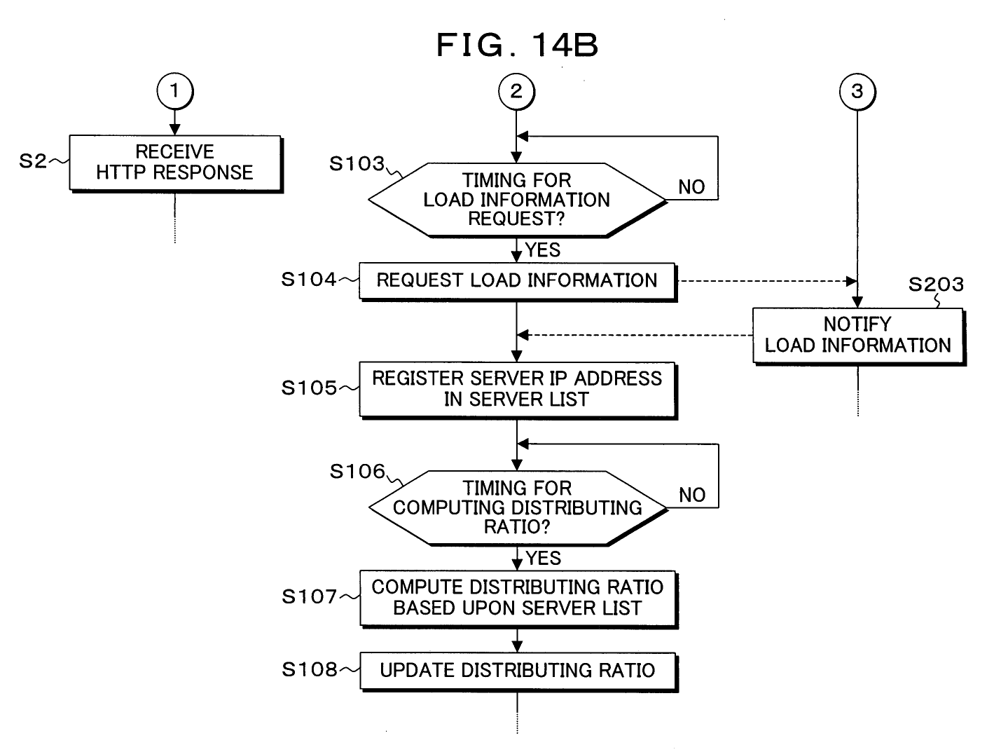

FIGS. 14A and 14B are time charts showing processing in the client, the preceding load distributing apparatus, the latter load distributing apparatus, and server in the embodiment of the information requesting type shown in FIG. 11. In FIGS. 14A and 14B, when the client 11-1 transmits an HTTP request packet in Step S1, packet transmission is conducted according to allocation based on a load distribution of the HTTP request packet via processngs in Step S101 of the preceding load distributing apparatus 14, Step S201 of the latter stage load distributing apparatus 16-1, and Step S301 of the server 20-1 like the case of the information notifying type shown in FIG. 8. The server 20-1 that has received the HTTP request packet from the client transmits an HTTP response packet to the client 10-1 in Step S2 via address conversions in respective apparatuses in Step S302, Step S202, and Step S102. On the other hand, the preceding stage load distributing apparatus 14 checks whether or not a timing is a load information request timing in Step S103. When it is determined that the timing is the load information request timing, the preceding stage load distributing apparatus 14 requests load information to apparatuses that are distribution destinations including the latter load distributing apparatus 16-1 in Step S104. The latter load distributing apparatus 16-1 receives the request to notify the number of working end servers connected to itself to the preceding stage load distributing apparatus 14 as load information in Step S203. The preceding stage load distributing apparatus 14 acquires the load information received from the allocation destination apparatuses including the latter load distributing apparatus 16-1, namely, the number of working servers to register the same in the server list in Step S105. Subsequently, the preceding stage load distributing apparatus 14 checks whether a timing is a calculating timing for the distribution ration in Step S106. When the timing reaches the calculating timing, the preceding stage load distributing apparatus 14 calculates the distribution ratio based upon the number of working servers in the server list in Step S107, and update the distribution ratio in Step S108.

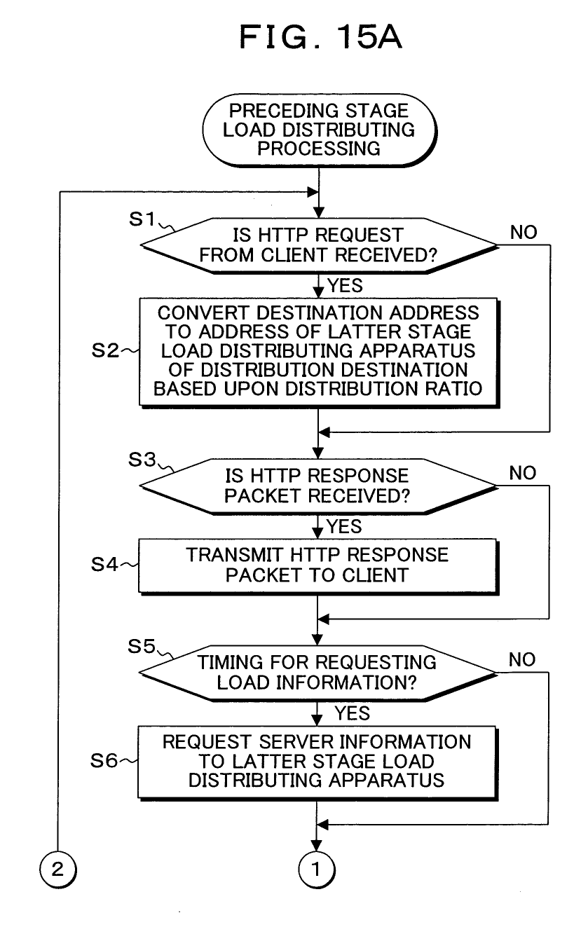

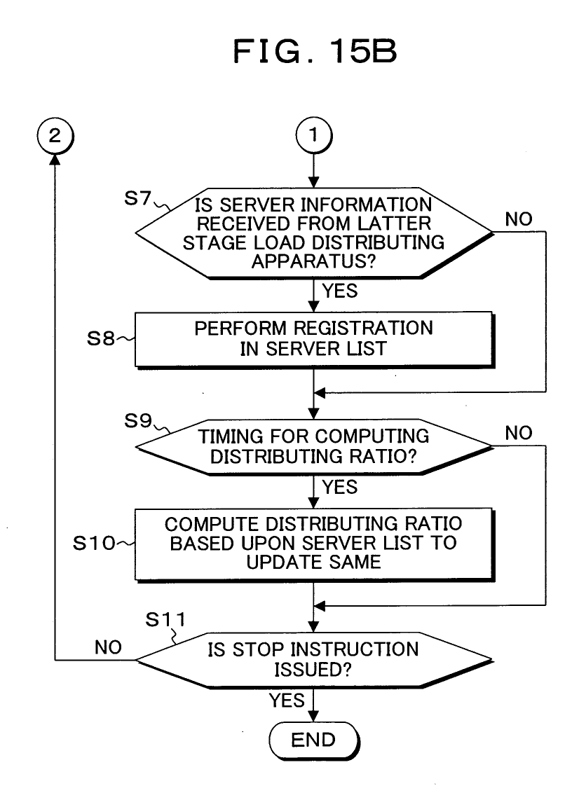

FIGS. 15A and 15B are flowcharts of a distribution processing performed by the preceding stage load distributing apparatus 14 in FIGS. 12A and 12B. In FIGS. 15A and 15B, when the preceding stage load distributing processing determines reception of an HTTP request packet form a client in Step S1, it converts a destination address to address of a latter stage load distributing apparatus that is an allocation destination based the distribution ratio to transmit the HTTP request packet in Step S2. When receiving an HTTP response packet in Step S3, the preceding stage load distributing processing converts an IP address to client to transmit the HTTP response packet to the client in Step S4. When determining that a timing is a load status request timing in Step S5, the preceding stage load distributing processing requests server information to the latter stage load distributing apparatuses and the SSL accelerator apparatuses in Step S6. When receiving server information from the latter stage load distributing apparatuses and the SSL accelerator apparatuses, for example, the preceding stage load distributing processing registers the number of working servers in Step S8. Further, when determining that timing is a calculating time for the distribution ratio, the preceding stage load distributing processing calculates a distribution ratio based upon the server list to update the same in Step S10. The processing of Steps S1 to S10 is repeated until a stop instruction is issued in Step S11.

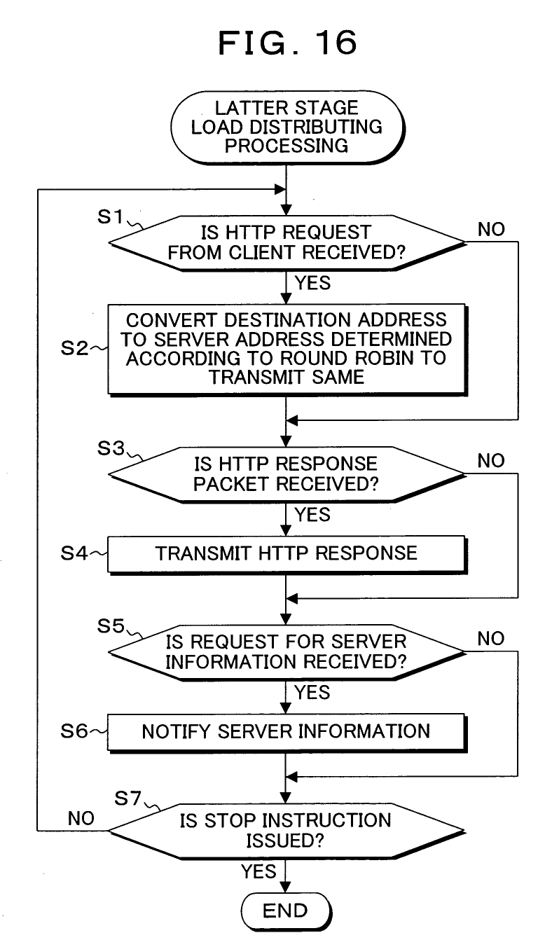

FIG. 16 is a flowchart of a distribution processing in the latter stage load distribution apparatus shown in FIGS. 12A and 12B, where the same processing is performed to the SSL accelerator apparatus. When determining reception of an HTTP request of a client in Step S1, the latter stage load distributing processing converts a destination IP address to a server address determined by, for example, a round robin to transit the HTTP request in Step S2. When determines reception of an HTTP response packet in Step S3, the latter stage load distributing processing converts the destination IP address to the preceding stage load distributing apparatus 14 to transmit the packet in Step S4. Further, when receiving a server information request in Step S5, the latter stage load distributing processing proceeds to Step S6 to notify, for example, the number of working servers connected to itself as sever information. The processing of Steps S1 to S6 is repeated until a stop instruction is issued in Step S7.

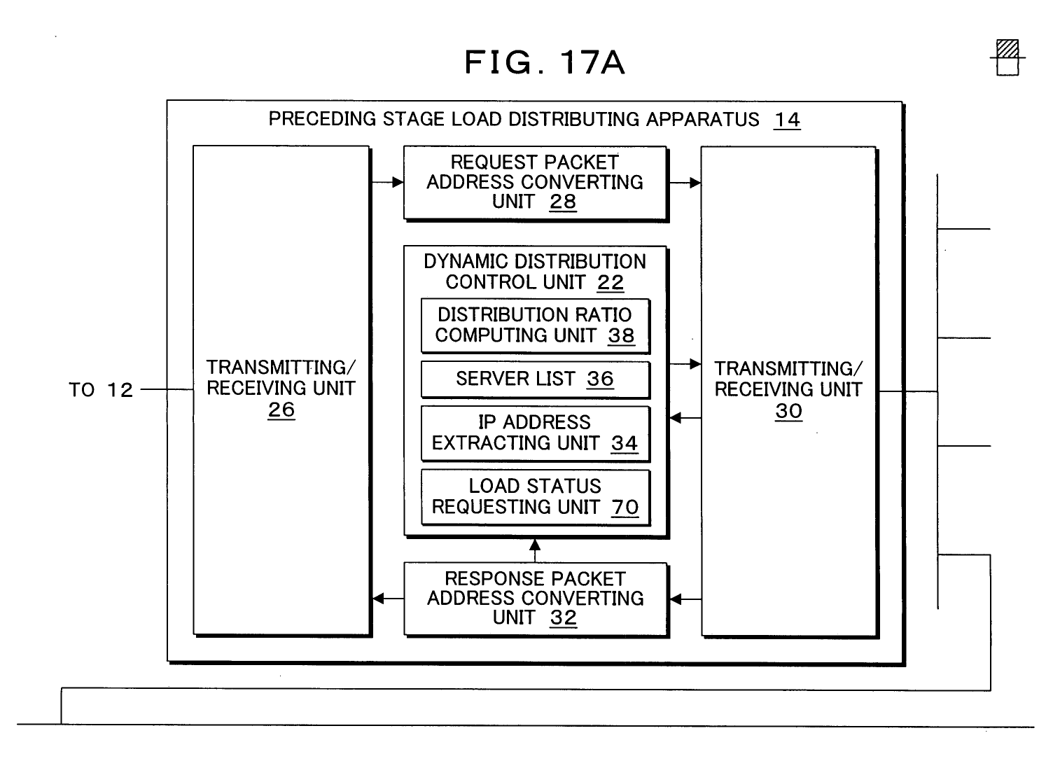

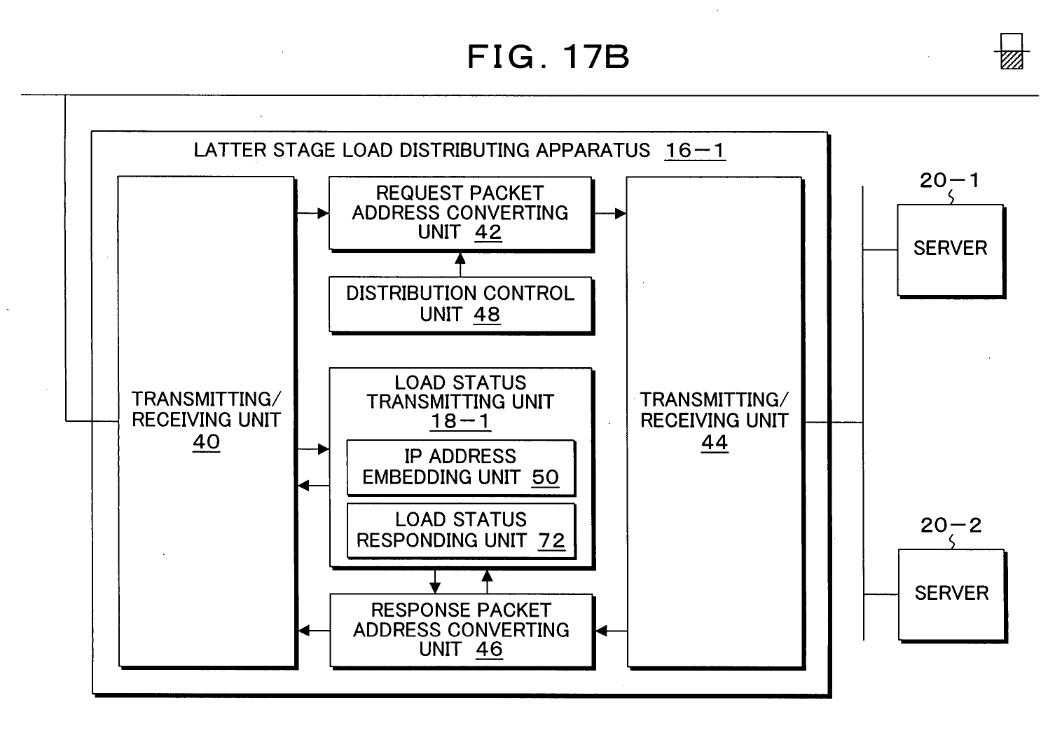

FIGS. 17A and 17B are block diagrams of a multi-stage load distributing apparatus taking a configuration of a composite type obtained by combining the information notifying type shown in FIGS. 4A and 4B and the information requesting type shown in FIG. 11. The whole configuration of the composite type is the same as that shown in FIG. 3, but the preceding stage load distributing apparatus 14 and the latter stage load distributing apparatuses 16-1, 16-2 are provided with functions shown in FIG. 11. The multi-stage load distributing apparatus of the composite type fundamentally sets a processing of the information notifying type as a first mode to extract server information embedded in an HTTP request packet and determine a distribution ratio. However, when an HTTP response packet can not be received only by the information notifying type at a calculating timing for the distribution ratio due to a temporary slowdown of a latter stage load distribution apparatus or an end server, such a possibility occurs that end server information can not be obtained. When a request frequency from a client is low, a request frequency for performing allocation to the latter stage load distributing apparatuses is also reduced. As a result, a working end server to which a request has not been allocated occurs, and server information about the end server can not be acquired. In view of these circumstances, when a situation that information about an end server can not be obtained in an ordinary working status occurs, end server information is acquired by performing switching from an aspect of the information notifying type set as a first mode to an aspect of the information requesting type set as a second mode.

FIGS. 17A and 17B are diagrams showing a functional configuration about the preceding stage load distributing apparatus 14 and the latter stage load distributing apparatus 16-1 in the multi-stage load distributing apparatus of the composite type. The preceding stage load distributing apparatus 14 is provided with transmitting/receiving units 26, 30, a request packet address converting unit 28, a response packet address converting unit 32, and a dynamic distribution control unit 22 like the case of the information notifying type shown in FIGS. 4A and 4B. An IP address extracting unit 34, a server list 36, and a distribution ratio calculating unit 38 provided in the dynamic distribution control unit 22 are also the same as those of the information notifying type shown in FIGS. 4A and 4B. Besides, a load status requesting unit 70 corresponding to the information requesting type is provided in the load status transmitting unit 24-1. On the other hand, the latter stage load distributing apparatus 16-1 is provided with transmitting/receiving units 40, 44, a request packet address converting unit 42, a response packet address converting unit 46, a distribution control unit 48, and a load status transmitting unit 24-1, and an IP address embedding unit 50 is provided in the load status transmitting unit 24-1. Besides, a load status responding unit 72 corresponding to the information requesting type is provided in the load status transmitting unit 24-1.

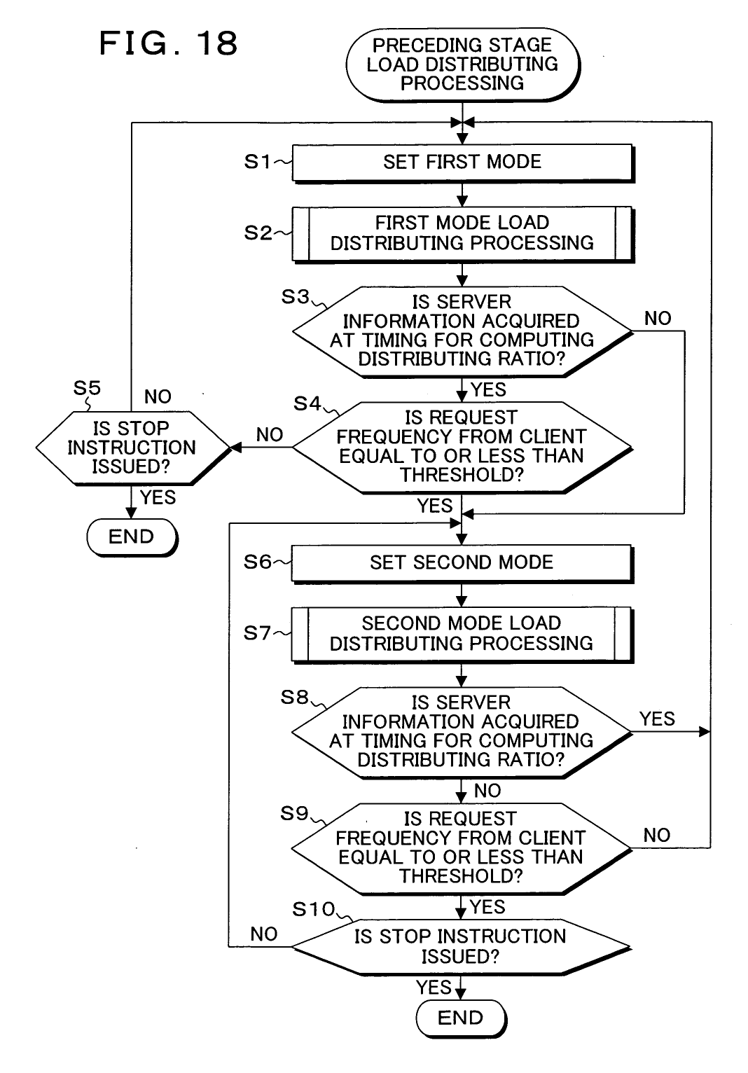

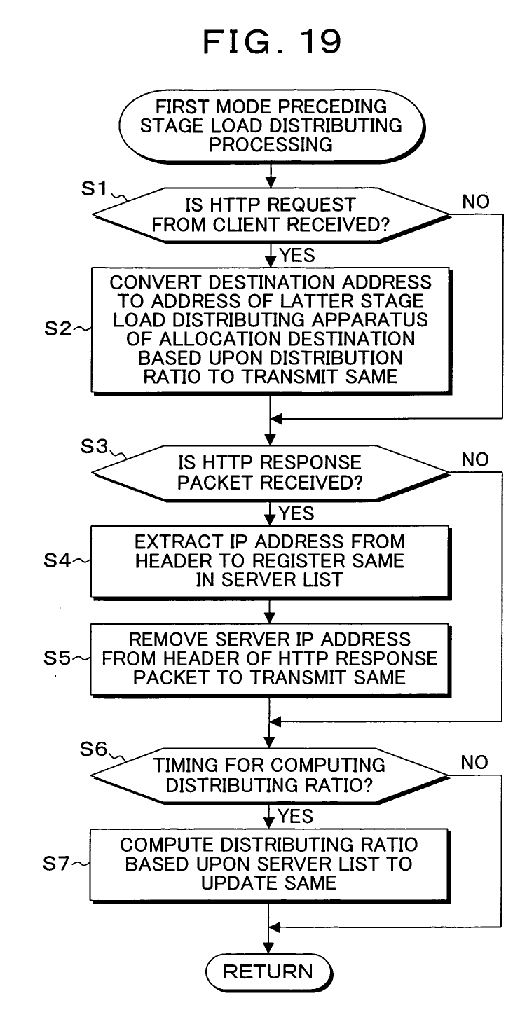

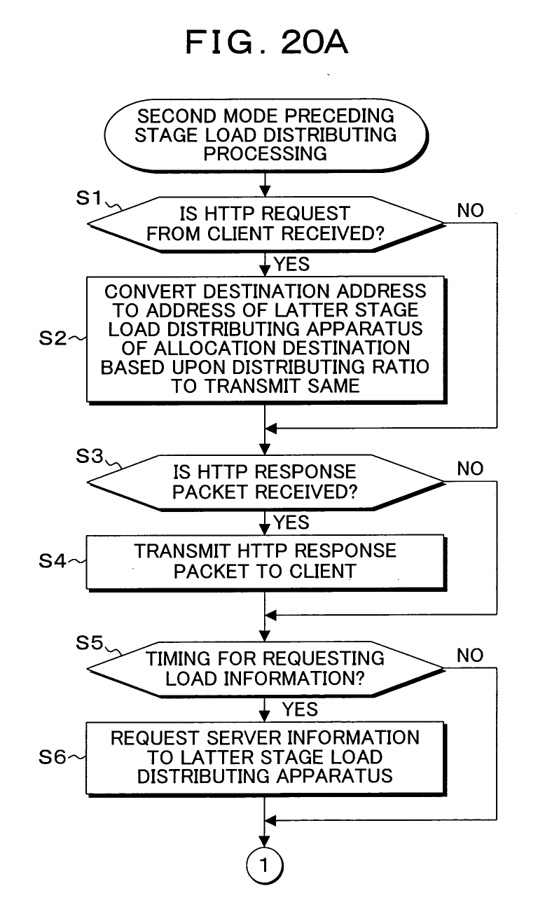

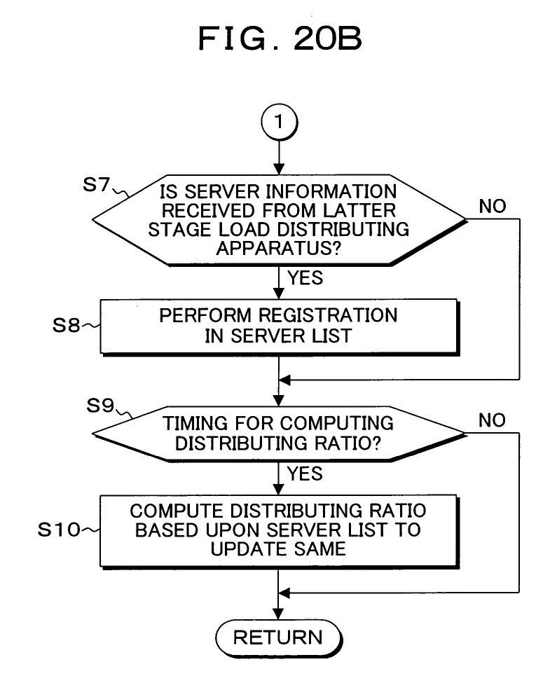

FIG. 18 is a flowchart of the preceding stage load distributing apparatus in the composite type shown in FIGS. 17A and 17B. In FIG. 18, the preceding stage load distributing processing of the composite type sets an operation mode of the information notifying type as a first mode in Step S1 and performs a first mode load distribution processing in Step S2. The first mode load distribution processing is a processing shown in a first mode preceding stage load distributing processing in FIG. 19, and Steps S1 to S7 are the same as processing of Step S1 to S7 in the preceding stage load distributing processing shown in FIG. 9. The preceding stage load distributing processing checks whether or not server information has been acquired at a calculating time for a distribution ratio in Step S3 shown in FIG. 18. When the server information can be acquired, the preceding stage load distributing processing checks whether or not a request frequency from a client is equal to or less than a threshold in Step S4. When the frequency exceeds the threshold, the preceding stage load distributing processing performs a load distributing processing set based upon the first mode set from the step S1 until a stop instruction is issued in Step S5. When server information has not been acquired at the calculating timing for the distribution ratio in Step S3, or when the request frequency from the client has been equal to or less than the threshold in Step S4, the preceding stage load distributing processing proceeds to Step S6, where the second mode constituting the aspect of the information requesting type, and performs the second mode load distribution processing in Step S7. The second mode load distribution processing in Step S7 is a processing shown in Steps S1 to S10 for the second mode preceding load distributing processing shown in FIGS. 20A and 20B, and this is the same as the preceding stage load distributing processing of the information notifying type shown in Steps S1 to S10 shown in FIGS. 15A and 15B. Referring to FIG. 18 again, the preceding stage load distributing processing checks whether or not server information could have been at the calculating timing for the distribution ratio in Step S8. When server information has not been acquired, the preceding stage load distributing processing checks whether or not a request frequency from the client is equal to or less than the threshold. When the request frequency is equal to or less than the threshold, the preceding stage load distributing processing performs the load distribution processing according to the second mode set from Step S6 until a stop instruction is issued in Step S10. When the preceding stage load distributing processing could have acquired server information at the calculating timing for the distribution ratio in Step S8, or when the request frequency from the client has exceeded the threshold in Step S9, the preceding stage load distributing processing performs setting of the first mode in Step S1 to return back to the first mode load distribution processing in step S2.

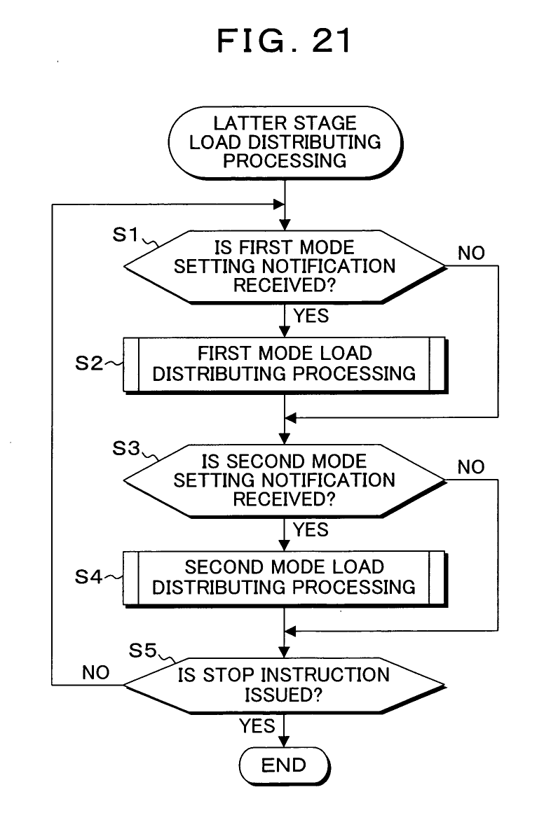

FIG. 21 is a flowchart of a distribution processing in the latter stage load distributing apparatus 16-1 of the complex type shown in FIGS. 17A and 17B. The latter stage load distributing processing shown in FIG. 21 checks presence/absence of reception of a first mode set notification from the preceding stage load distributing apparatus in Step S1. When receiving the set notification, the latter stage load distributing processing performs the first mode load distribution processing in Step S2. Subsequently, the latter stage load distributing processing checks whether or not a second mode set notification has been received from the preceding stage load distributing apparatus 14. When receiving the set notification, the latter stage load distributing processing performs the second mode load distributing processing in Step S4. Such a processing of Steps S1 to S4 is repeated until a stop instruction is issued in Step S5.

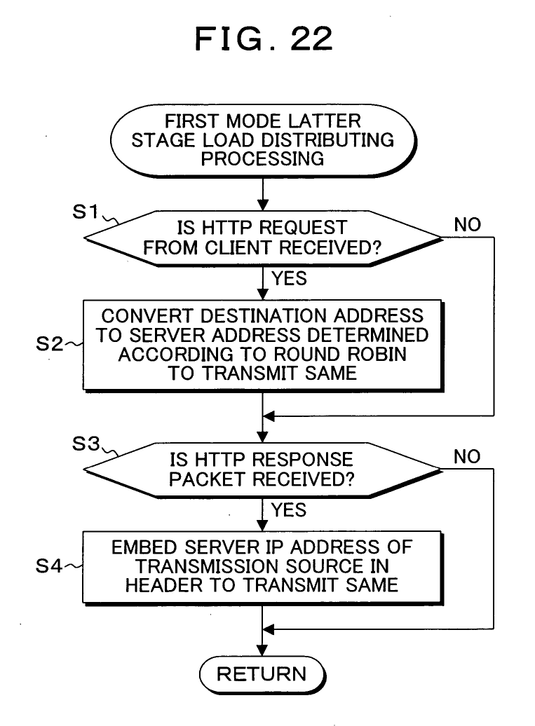

FIG. 22 is a flowchart of the first mode load distributing processing in the latter stage load distributing apparatus in Step S2 shown in FIG. 21, where a processing in Steps S1 to S4 is the same as the processing in Steps S1 to S4 shown in the latter stage load distributing processing of the information notifying type shown in FIG. 10.

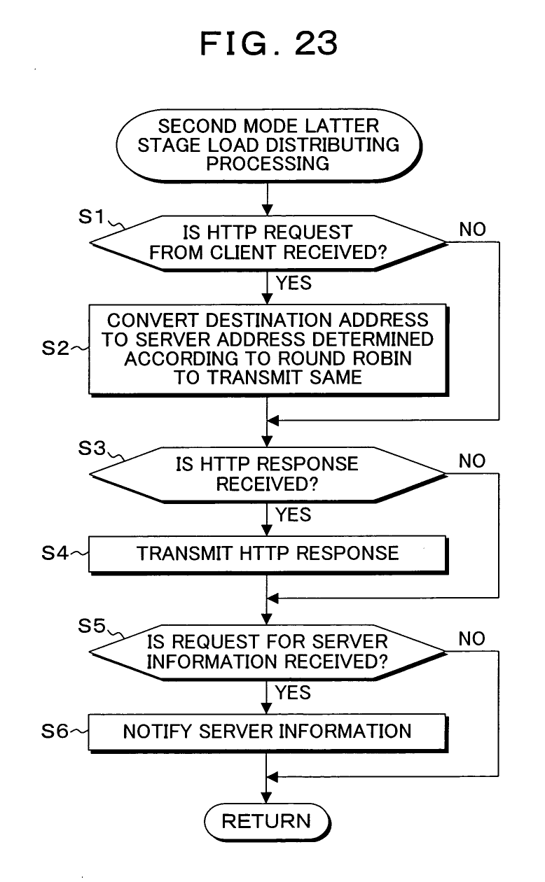

FIG. 23 is a flowchart of the second mode load distributing processing in Step S4 shown in FIG. 21, where a processing in Steps S1 to S6 is the same as the processing in Step s1 to S6 in the latter stage load distributing apparatus in the case of the information requesting type shown in FIG. 16. In the present invention, a program for the preceding stage load distributing processing and a program for the latter stage load distributing processing performed in the preceding load distributing apparatus 14, the latter stage load distributing apparatuses 16-1, 16-2, and the SSL accelerator apparatuses 18-1, 18-2 that are shown in FIG. 3 and FIG. 11 are provided, and the programs have contents corresponding to the flowcharts shown in FIG. 9, FIG. 10, FIG. 15A, FIG. 15B, FIG. 16, and FIG. 18 to FIG. 23. The present invention includes proper modifications without injuring its object and merit. In the information requesting type of the above embodiment, the case that the latter stage load distributing apparatuses and the SSL accelerator apparatuses corresponding to HTTP are arranged as the apparatuses of the latter stage type has been explained as an example. Besides, such a constitution may be employed that apparatuses having various functions such as an NAT apparatus and a firewall apparatus are disposed as an allocation destinations and end servers are connected thereto. Further, the present invention is not limited by the values shown in the embodiments.

What is claimed is:

1. A multi-stage load distributing apparatus that is constituted of a preceding stage load distributing apparatus connected to a network, a plurality of latter stage load distributing apparatuses connected to the preceding stage load distributing apparatus, and one or plural servers connected to each latter stage load distributing apparatus, where, after a request from a client is distributed from the preceding stage load distributing apparatus to either of the latter stage load distributing apparatuses, the request is distributed to either of the servers, wherein
the latter-stage load distributing apparatus is provided with a load status transmitting unit that transmits a status of a server connected to the latter stage load distributing apparatus itself to the preceding stage load distributing apparatus, and
the preceding stage load distributing apparatus is provided with a dynamic distribution control unit that determines a status of the server based upon transmission information from a load status transmitting unit of the latter stage load distributing apparatus to perform allocation control to the request from the client.

2. The apparatus according to claim 1, wherein
the load status transmitting unit of the latter stage load distributing apparatus embeds transmission information indicating statuses of the servers in a client response packet from the server connected to itself to notify the client response packet; and
the dynamic distribution control unit of the preceding stage load distributing apparatus extracts the transmission information from the client response packet to perform allocation control.

3. The apparatus according to claim 1, wherein the load status transmitting unit of the latter stage load distributing apparatus embeds a server IP address in a header of a client response packet from the server connected to the latter status load distributing apparatus itself to perform notification, and
the dynamic distribution control unit of the preceding stage load distributing apparatus extracts the server IP address from the header of the client response packet and recognizes the number of servers for each the latter stage load distributing apparatus operating normally to perform allocation control.

4. The apparatus according to claim 1, wherein an information transmitting unit of the later stage load distributing apparatus generates a response of information indicating a status of the server connected to the latter stage load distributing apparatus itself to the request from the preceding stage load distributing apparatus, and
the dynamic distribution control unit of the preceding stage load distributing apparatus requests information indicating a status of the server to the latter stage load distributing apparatus and recognizes the status of the server from response information from the later stage load distributing apparatus to perform allocation control.

5. The apparatus according to claim 1, wherein
the load status transmitting unit of the latter stage load distributing apparatus embeds transmission information indicating a status of the servers in a client response packet from the server connected to itself in a set status of a first mode and generates a response of information indicating the status of the servers connected to itself to a request from the preceding stage load distributing apparatus in a set status of a second mode; and
the dynamic distribution control unit of the preceding stage load distributing apparatus extracts the transmission information from the client response packet to perform allocation control in the set status of the first mode, and requests information indicating the status of the servers to the latter stage load distributing apparatus and recognizes the status of the servers from response information from the latter stage load distributing apparatus to perform allocation control in the set status of the second mode.

6. The apparatus according to claim 1, wherein
when a client response packet has not been received from the latter stage load distributing apparatus at a timing of calculation for a load distribution ratio in the preceding stage load distributing apparatus in the set status of the first mode, switching to the set status of the second mode is performed.

7. The apparatus according to claim 1, wherein
when it is determined in the preceding stage load distributing apparatus that a request frequency from a client is low in the set status of the first mode, switching to the set status of the second mode is performed.

8. The apparatus according to claim 5, wherein, in the set status of the first mode,
the load status transmitting unit of the latter stage load distributing apparatus embeds a server IP address in a header of a client response packet from the server connected to the latter status load distributing apparatus itself to perform notification, and
the dynamic distribution control unit of the preceding stage load distributing apparatus extracts the server IP address from the header of the client response packet and recognizes the number of servers for each the latter stage load distributing apparatus operating normally to perform allocation control.

9. A multi-stage load distributing method that is constituted of a preceding stage load distributing apparatus connected to a network, a plurality of latter stage load distributing apparatuses connected to the preceding stage load distributing apparatus, and one or plural servers connected to each latter stage load distributing apparatus, where, after a request from a client is distributed from the preceding stage load distributing apparatus to either of the latter stage load distributing apparatuses, the request is distributed to either of the servers, the multi-stage load distributing method comprising:
a load status transmitting step of transmitting a status of the server connected to the latter stage load distributing apparatus to the preceding stage load distributing apparatus; and
a dynamic distribution control step of determining a status of the server based upon transmission information obtained by the load status transmitting step to perform allocation control of the request from the client.

10. The method according to claim 9, wherein
the load status transmitting step embeds transmission information indicating a status of the server in a client response packet from the server to transmit the client response packet by the latter stage load distributing apparatus; and
the dynamic distribution control step extracts the transmission information from the client response packet to perform allocation control by the preceding stage load distributing apparatus.

11. The method according to claim 9, wherein
the load status transmitting step embeds IP address of the server in a header of a client response packet from the server to transmit the client response packet by the latter stage load distributing apparatus; and
the dynamic distribution control step extracts the server IP address from the header of the client response packet and recognizes the number of servers for each the latter stage load distributing apparatus operating normally to perform allocation control by the preceding stage load distributing apparatus.

12. The method according to claim 9, wherein
the load status transmitting step generates a response of information indicating a status of the server connected to itself to a request from the preceding stage load distributing apparatus by the latter stage load distributing apparatus; and
the dynamic distribution control step requests the information indicating the status of the server to the latter stage load distributing apparatus and recognizes the status of the server from response information from the latter stage load distributing apparatus to perform allocation control by the preceding stage load distributing apparatus.

13. The method according to claim 9, wherein
the load status transmitting step embeds transmission information indicating a status of the server in a client response packet from the server in a set status of a first mode and generates a response of information indicating the status of the server connected to itself to a request from the preceding stage load distributing apparatus in a set status of a second mode by the latter stage load distributing apparatus; and
the dynamic distribution control step extracts the transmission information from the client response packet to perform allocation control in the set status of the first mode, and requests information indicating the status of the servers to the latter stage load distributing apparatus and recognizes the status of the servers from response information from the latter stage load distributing apparatus to perform allocation control in the set status of the second mode.

14. The method according to claim 9, wherein
when a client response packet has not been received from the latter stage load distributing apparatus at a timing of calculation for a load distribution ratio in the preceding stage load distributing apparatus in the set status of the first mode, switching to the set status of the second mode is performed.

15. The method according to claim 9, wherein
when it is determined in the preceding stage load distributing apparatus that a request frequency from a client is low in the set status of the first mode, switching to the set status of the second mode is performed.

16. The method according to claim 13, wherein
in the set status of the first mode, the load status transmitting unit embeds a server IP address in a header of a client response packet from the server connected to the latter status load distributing apparatus itself to perform notification, and
the dynamic distribution control unit extracts the server IP address from the header of the client response packet and recognizes the number of servers for each of the latter stage load distributing apparatuses operating normally to perform allocation control by the preceding stage load distributing apparatus.
